(19) United States
(12) Patent Application Publication
(10) Pub. No.: US 2003/0064225 A1
(43) Pub. Date: Apr. 3, 2003

(54) Diamond-coated member

(75) Inventors: Tsuneaki Ohashi, Ogaki-City (JP); Makoto Murai, Nagoya-City (JP); Hiromichi Kobayashi, Yokkaichi-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/072,819

(22) Filed: Feb. 8, 2002

Related U.S. Application Data
(60) Provisional application No. 60/269,117, filed on Feb. 15, 2001.

(51) Int. Cl. B32B 9/00

(52) U.S. Cl. 428/408

(57) ABSTRACT

A diamond-coated member includes a basal material such as aluminum nitride, and a diamond thin film coating at least one part of a surface of the basal material, being adhered thereto, and has corrosion-erosion resistance. Adhesion strength between the thin film and the basal material is 15 MPa or more. Or, in diamond thin film, degree of orientation of diamond {220} plane present in faces parallel to the basal material is expressed by following formula:

[Im220/(Im220+Im111)]/[Ip220/(Ip220+Ip111)]<1.

The diamond-coated corrosion-erosion resistant member has excellent corrosion-erosion resistance, and is used mainly for a semiconductor producing apparatus; being preferably applied as a member inside a reaction chamber where a substrate, represented by silicon wafer, is exposed to plasma, corrosion gas or the like, inclusive of rings, a chamber inner lining, a gas shower plate, nozzles, a susceptor, an electrostatic chuck, a heater, or the like.

### BACKGROUND OF THE INVENTION AND THE RELATED ART

The present invention relates to a diamond-coated member mainly used for a substrate treating device, the member having excellent corrosion-erosion resistance. More specifically, the present invention relates to a diamond-coated member which is preferably used particularly as a member in a reaction chamber where a substrate, represented by a silicon wafer, is exposed to plasma, corrosive gas or the like—involving, for instance, rings, a chamber inner lining, a gas shower plate, nozzles, a susceptor, a dome, a bell-jar, an electrode, a heater, and so forth—and which is made more useful as a member exposed to plasma at high temperature by providing orientation thereto.

The current of the IT Revolution, following the agrarian revolution and the industrial revolution, is surging. To further develop the economy and promote an affluent and vibrant society in 21^{st} century, one theme is to reform the socioeconomic structure through IT (Information and Communications Technology), and a system therefor is under construction at the national level. Particularly, it is said that the key is to further develop and stimulate IT as a crucial industry by enhancing software, such as opening the telecommunications industry and introducing competitive principles to the industry, extending contents, and accelerating responses to needs for a better and greater variety of services.

However, it is hardware that is supporting such communications and software, and is undoubtedly semiconductors—the staple of the industry that has been already supplied for over twenty-five years as parts for various hardware. Semiconductors are necessary for the continuation of society, and ICs (Integrated Circuits) of semiconductors are used in many kinds of equipment, including equipment that was not conventionally considered as electronic equipment.

Semiconductors have evolved since processing power has been continuously improved on the basis of the so-called Moore's Law, which states that processing power will double every 24 months, and thus semiconductor performance has been progressively innovated. New production technologies have been constantly introduced. Barriers have been broken by technological innovations, regardless of methods or materials, such as the recent application of SOI (Silicon On Insulator) to substrates and so forth, or the adoption of copper for wiring, the use of argon fluoride excimer laser to draw circuits, and so forth. Processing power has been improving at accelerating speed, doubling every 18 months. The improvement of processing power basically depends on finer circuits and cleaner production processes.

In order to integrate more ICs on the same or a smaller area, a circuit has to be made finer. The design rule, in other words, the minimum wiring spacing of a circuit, has been continuously reduced in size, and is currently 0.18 μm to 0.13 μm, gradually shifting to the size of 0.10 μm. Moreover, in order to improve the reliability of a semiconductor having a finer circuit, it is important to prevent dust from adhering to the circuit. In general, as a requirement, there should be almost no fine particles as large as 1/10 of the design rule.

Normally, semiconductors are produced through processes such as reaction to a highly pure chemical and highly pure gas in a clean room, and washing with extra pure water. In all processes, not only the fine particles but also impurities such as metal ions, organic substances, and so forth are removed to the fullest extent. Semiconductors are produced by using materials that hardly contain impurities, in a clean environment.

In semiconductor production processes, a super clean reaction process is normally required, and a highly pure material is used in a clean state. However, in order to carry out such a desirable reaction process for semiconductors, a material has to be kept highly pure before the reaction process. In other words, the preparation of a highly pure material with no impurities would become meaningless if a substrate or a chip is contaminated in the course of its processes with impurities derived from phenomenon other than the intended reactions, such as, corrosion of members or increased elution from the members in a supply channel to a production apparatus or in the production apparatus.

A highly pure material, in consideration of the concept of equilibrium, is likely to dissolve a contacting object, and is contaminated with the dissolved portion therefrom. Many chemicals and gases used in semiconductor production processes often contain many reactive active species. Accordingly, members of an apparatus that is used in semiconductor production processes are required to have excellent stability without causing corrosion or elution due to contact with chemicals and gas containing many such active species, wash water, and so forth. This is a problem to be solved for members of a semiconductor producing apparatus. For instance, if members are made of polycrystalline ceramics, fine particles are likely to generate, which is not preferable. As a material which hardly corrodes or elutes and has excellent corrosion resistance, graphite, metals such as highly passive stainless steel, or engineering plastic such as PEEK (Poly Ether Ether Ketone), and so forth have been used.

Specifically, for example, problems regarding members of a semiconductor producing apparatus for use in processes such as CVD (Chemical Vapor Deposition) and etching can be given. Furthermore, as a detailed example, the problems of a heater for heating a substrate for use in a CVD apparatus, and of peripheral members for a substrate can be given.

Semiconductor production processes, even with continuous technical innovation, remain unchanged basically, and comprise the repetition of the steps of lithography, introduction of impurities, and formation of a thin film. CVD, etching, and so forth are the main production techniques thereof. CVD is mainly used for the formation of thin films, such as the formation of oxide films as insulating films, and is a technique based on chemical catalytic reaction under high temperature condition. There are thermal CVD, plasma CVD, and so forth. A CVD apparatus has a heater for heating a substrate as a heat source in any method. In a CVD apparatus, synthesis gas or reaction gas is used during the growth of a thin film, such as monosilane, tungsten hexafluoride, TEOS (Tetraethyl-orthosilicate), ozone, hydrogen, and so forth. Gas is used during cleaning, such as nitrogen trifluoride, chlorine trifluoride, tetrafluoromethane (Fleon 14), hydrogen fluoride, and so forth. These gases are corrosive. Moreover, in the etching process, various types of carbon fluoride gases, or etching gas such as nitrogen, oxygen, chlorine, boron chloride and hydrogen bromide are used in a plasma state. Accordingly, a heater for heating a substrate and peripheral members for a substrate of a CVD apparatus mentioned as examples, have to resist to corrosion due to active species or erosion due to ion bombardment, or physico-chemical decays as a joint effect thereof, even when being exposed to these corrosive gases. In other words, a heater for heating a substrate and peripheral members for a substrate need to have thermal and mechanical durability without generating impurities such as fine particles, and without contaminating a substrate during processes in a corrosive environment under high temperature or the repeated cycles of raising and lowering temperature.

As a heater for heating a substrate, for instance, the one in which a heater element is coated with metal such as stainless steel and INCONEL has been conventionally used. Stainless steel and INCONEL are highly corrosion-resistant metals, and have provided durability to certain extent to heaters for heating a substrate in a CVD apparatus.

However, as gases for use in CVD become more corrosive, more undesirable impurities such as oxides, chlorides and fluorides generated by reactions with metal increase, and heaters lose their durability.

Thus, there are proposed an indirect heater whose heating element is arranged outside a reactor of a CVD apparatus and is separated from corrosive gas so as not to be directly exposed to corrosive gas. An indirect heater is a heater consisting of a heater element and a susceptor to be heated on which a substrate is loaded thereon. For instance, an infrared ray lamp is used for a heater element, and a reactor of a CVD apparatus is provided with an infrared ray transmitting window, irradiating infrared rays to a susceptor to be heated in the reactor so as to heat a substrate on the susceptor to be heated. When graphite or the like that is more corrosion resistant than stainless steel and so forth is used for a susceptor to be heated, longer stable operation could be expected.

However, since this heater uses indirect heating, it has problems such as large heat loss, increase in operation costs, a time-consuming period for raising temperature, and reduction in throughput. Moreover, a thin film by CVD adheres to an infrared ray transmitting window, causing such problems as increasing hindrance to infrared ray transmission, resultantly heating of infrared ray transmitting window, and so forth. The time spent on maintenance was also rather long. Moreover, since a susceptor to be heated is made of graphite or the like, corrosion is inevitable even in this type.

Problems concerning the members of a semiconductor producing apparatus include the problem of a dry etching apparatus, especially members in a chamber, as another example. A dry etching apparatus is, for example, an apparatus for etching an unmasked thin film, such as an unmasked oxide film, and has an electrode inside a chamber to generate plasma from an introduced gas consistent with the thin film. When the erosion of members is accelerated by ion bombardment of plasma; or member components are sputtered by ion bombardment of plasma, a substrate will be contaminated. As the design rule is further miniaturized to nearly 0.1 μm, such a problem becomes more apparent than before. Additionally, since high frequency power to generate plasma is rising, even erosion resistant members are bombarded with ions and thus exposed to a harsher environment while being heated at high temperature.

In order to solve these problems concerning members of a semiconductor production apparatus, the application of fine ceramics having excellent corrosion resistance, such as aluminum nitride and silicon nitride, has been conventionally proposed.

JP-B-6-28258 discloses a heating apparatus for a semiconductor substrate that consists of a heater having a heater element embedded in ceramics and a ceramic supporting member. FIG. 5 is a cross-sectional view, showing one embodiment of a semiconductor producing apparatus including the heating device for heating a semiconductor substrate thereof. The figure shows a CVD apparatus 24, which has a ceramic disc-like heater 23 at a reactor 21 through a ceramic supporting member 26 and has a built-in heating device 22 for directly heating a substrate. Since this heating device 22 is of a direct heating type, heat loss is small. Gas for CVD is supplied into the reactor 21, and the disc-like heater 23 and the supporting member 26 are exposed to corrosive atmosphere. However, as the heater and the supporting member are made of dense and gas tight ceramics such as aluminum nitride and sialon as a material, they do not generate impurities.

Moreover, JP-B-8-8215 discloses a heating device for a semiconductor substrate in which a temperature difference between the internal and external circumferences of a disc-like heater is reduced by changing a method of supporting the heater with a reactor from that of the above-mentioned heating device 22. FIG. 6 is a cross-sectional view, showing one embodiment of a semiconductor producing apparatus including the heating device for a semiconductor substrate thereof. The figure shows a CVD apparatus 34 which has a ceramic disc-like heater 33 at a reactor 31 through a ceramic supporting member 36 and has a built-in heating device 32. Like the heating device 22, the heating device is of a direct heating type, so that heat loss is small. Since the disc-like heater 33 and the supporting member 36 are made of dense and gas tight ceramics such as aluminum nitride and sialon as a material, they do not generate impurities even with exposure to a corrosive atmosphere.

Additionally, U.S. Pat. No. 5,231,690, U.S. Pat. No. 5,490,228, JP-A-2000-44345 and the like also disclose the embodiments wherein ceramics have been applied. However, recent years, a heater has been increasingly in demand to have a tolerance for a process at more temperature and superior thermal uniformity in order to improve throughput and yields or to form a new thin film.

As a response to such a demand, members of a substrate treating device that are coated with diamond, diamond-like carbon or the like, are disclosed. JP-A-10-70181 discloses an improved electrostatic chuck for holding and carrying a substrate with electrostatic force in a substrate treating device, in which a thin diamond film of 1 to 50 μm is used as a coat for the electrostatic chuck. By coating members with a diamond film, a body of the electrostatic chuck made of, for instance, stainless steel, ceramics or the like is prevented from generating particles, thus preventing the contamination of a substrate and requiring no dummy substrate during a chamber cleaning.

JP-A-10-96082 proposes a substrate treating device having a chamber which is coated with a carbon-based film containing diamond or diamond-like carbon. A thin 1 to 50 μm carbon-based film is used as a coat for holding a chamber surface in the substrate treating device. Thus, the endurance of chamber members in contact with reactive materials improves during an etching process, a cleaning process and so forth; life is prolonged and the throughput of substrate treatments thus is improved; and the generation of fine particles is minimized.

Diamond is the hardest material, having the highest thermal conductivity and high resistivity. Diamond has been used for tools and radiating plates. Diamond is also a stable compound based on high bond energy. Moreover, diamond basically contains no components other than carbon, so that it does not cause contamination of metal ions. Furthermore, although diamond is expensive, it can be used practically by using it in a form of thin coat like this, with overcoming economic difficulties.

Accordingly, semiconductor producing apparatuses having members coated with diamond thin films as proposed in JP-A-10-70181 and JP-A-10-96082, are preferable, showing corrosion resistance under a corrosive atmosphere and preventing the generation of contaminants such as fine particles and metal ions.

However, the object members of diamond or diamond-like carbon coating are limited to an electrostatic chuck and a chamber in those proposals. As described above, there is no description, regarding a heater for heating a substrate, a ring and so forth which are in contact with corrosive gas at high temperature where a corrosive reaction is inclined to accelerate. Diamond is composed of carbon atoms, so that it has chemical weaknesses assumed from the fact, for instance, that it is easily oxidized under a high-temperature air to form carbon dioxide and thus, dissipating. Therefore, one may not judge clearly that diamond can show sufficient corrosion resistance over a long period under high temperature according to JP-A-10-70181 and JP-A-10-96082. These proposals also have no specific descriptions on basal materials of members to be coated.

The present invention has been made in consideration of the above-mentioned problems. The object thereof is to provide a diamond-coated member that is fully resistant against more corrosive gas, more powerful plasma or the like in a harsher corrosive atmosphere of a semiconductor producing process, and that prevents the generation of contaminants such as fine particles and metal ions. Furthermore, the member is applicable as a heater for heating a substrate and peripheral members for a substrate under more temperature.

### SUMMARY OF THE INVENTION

The present inventors have confirmed that diamond can resist against corrosive gas used in production processes (including self-cleaning process) of semiconductors, displays such as liquid crystals, PDPs, organic ELs, or substrates for optical devices as a result of carrying out repeatedly various experiments on diamond as a highly corrosion resistant material and on members to which the diamond is applied. And, we have found that a diamond film—in which diamond {220} plane, in particular, are oriented at a given degree or less in faces parallel to a basal material, that is, faces to which ions are bombarded, in a member in which diamond is adhered as a thin film to coat the basal material—shows strong erosion resistance even when the film is bombarded with ions at high temperature.

In other words, the present invention provides a diamond-coated corrosion-erosion resistant member; comprising a basal material and a thin film covering at least a part of the surface of a basal material and being adhered thereto;

characterized in that the thin film is a diamond film having diamond as a main crystal phase; and that, in the diamond film, a degree of orientation of diamond {220} plane in faces present in faces parallel to the basal material is expressed by the following formula:

[Im220/(Im220+Im111)]/[Ip220/(Ip220+Ip111)]<1.

The degree of orientation is more preferably 0.75 or less.

Herein, Im220 indicates X-ray diffraction intensity of diamond {220} plane in faces parallel to the basal material, and Ip111 indicates X-ray diffraction intensity of non-oriented {111} plane. As the X-ray diffraction intensity in a non-oriented state, the data reported in the JCPDS card (Joint Committee On Powder Diffraction Standards: Powder Diffraction File issued by International Center For Diffraction) 6-0675 was used. Every X-ray source is Cu Kα rays. Angles of diffraction 2θ are 75.3° for I220 and 43.9° for I111.

The diamond-coated corrosion-erosion resistant member will be explained in detail below.

In the diamond-coated corrosion-erosion resistant member of the present invention, adhesion strength between the thin film and the basal material is preferably 15 MPa or more. Diamond has excellent corrosion resistance, but is costly. Thus, it is preferable that diamond is used not as a basal material but as a thin film adhered to a surface; thereby, the compatibility with the economics, as one of the problems of diamond, can be attained. However, in applying a diamond film as an adhered thin film, adhesion strength to a basal material depends on thermal barriers at an interface between the diamond thin film and the basal material, and is important in consideration of heater characteristics such as heating efficiency and thermal uniformity. Also, for thermal stress during a high-temperature retention period or a period for raising and lowering temperature, it is necessary to prevent the thin film from peeling off from the basal material. When the adhesion strength is 15 MPa or more, such requirements may be satisfied. More preferably, the adhesion strength is 20 MPa or more.

The basal material preferably has high thermal conductivity. In relatively measurable room temperature values, thermal conductivity of 50 W/mK or more is preferable. For example, at least one member of a metal material or a compound material selected from the group consisting of silicon carbide, metal silicon, silicon nitride, aluminum nitride and boron nitride, may be preferably used. Diamond or highly thermal conductive silicon nitride ceramics are also applicable. Moreover, it is preferable to use single crystal silicon as a basal material. Thermal conductivity is more preferably 80 W/mK or more in room temperature values.

Furthermore, it is preferable to include at least one kind of a metal material or a compound material selected from the group consisting of silicon carbide, silicon nitride, aluminum nitride, silicon, carbon, tungsten and molybdenum, between the basal material and the thin film. Due to the formation of an intermediate layer thereby, the improvement of adhesion strength may be expected, and the deposition of diamond becomes controllable. As long as the adhesion strength of 15 MPa or more, more preferably, 20 MPa or more is attained, the intermediate layer may be formed by a well-known method. For instance, CVD, PVD, plasma-spraying, paste or slurry baking, and so forth may be included. When the intermediate layer has conductivity, the intermediate can be used as an electrode such as a high-frequency electrode by attaching a terminal thereto.

In the diamond-coated corrosion-erosion resistant member of the present invention, a coated area ratio of the thin film relative to a surface area of the basal material is preferably 10 to 90%, more preferably, 60 to 80%. Moreover, the total weight of elements of the group 1a to the group 3b contained in the thin film is preferably 50 one millionth or less of the total weight of the thin film in order to prevent the film from contamination with metal. Li, Na, K, Rb, Cs, Be, Mg, Ca, Sr, Ba, Sc, Y, La, Ce, Pr, Nd, Pm, Sm, Eu, Gd, Tb, Dy, Ho, Er, Tm, Yb, Lu, Ti, Zr, Hf, V, Nb, Ta, Cr, Mo, W, Mn, Re, Fe, Ru, Ir, Ni, Pd, Pt, Ag, Au, Zn, Cd, Hg, B, Al, Ga, In, and Tl are exemplary of the elements of the group 1a to the group 3b. Impurities may be analyzed by, for instance, GD-MASS (Glow Discharge Mass Spectroscopy: one type of mass spectrometry) after separating only the diamond film.

In the diamond-coated corrosion-erosion resistant member of the present invention, it is preferable to dope nitrogen or fluorine to diamond from which the thin film is formed, since erosion resistance improves. Besides, about 0.01-10 mass % of silicon may be contained. In this case, it is effective for improving resistance to, particularly, oxygen plasma. Corrosion loss of the thin film due to 400° C. biased nitrogen trifluoride plasma is preferably 5 mg/cm²·h or less.

In a diamond-coated corrosion-erosion resistant member the present invention, the thin film preferably comprises a plurality of diamond films having different electric resistivity. For instance, when the diamond thin film has not a single layer structure but a multilayer structure and has a low resistance layer as an outermost layer and a high resistance layer as an innermost layer, it can insulate the inside of the member while preventing electrification. On the contrary, when the outermost layer is a high resistance layer and the innermost layer is a low resistance layer, a thin dielectric layer may be provided. Since diamond has high withstand voltage, high voltage tends to be applied on a thinner part. Thus, such a structure is particularly effective. Incidentally, such a structure is particularly suitable, for example, when a diamond thin film is applied to a dielectric layer of an electrostatic chuck. Also, with a multilayer structure, electromagnetic characteristics vary when thinning occurs due to corrosion or the like, so that deterioration may be detected. The diamond film is easily made from polycrystalline diamond, but the outermost film may be single crystal diamond. These multi-layered diamond films can be obtained through several film-forming steps. At this time, the films are preferably formed with a gas composition, temperature, plasma power, and the like being successively changed in every step because bonding force between the layers can be further enhanced.

In the diamond-coated corrosion-erosion resistant member of the present invention, surface roughness of the thin film is preferably 1 to 100 μm. The reason thereof is that the microscopic recesses and projections of the diamond film are expected to improve thermal uniformity. It is considered, due to this particular surface form of the diamond film, heat rays from the basal material are irregularly reflected, thus improving thermal uniformity. More preferably, the surface roughness of the thin film is 3 to 10 μm.

Moreover, the thickness of the diamond thin film is preferably 1 to 500 μm in consideration of the balance between costs and corrosion-erosion resistance. Diamond has high thermal conductivity, and this characteristic should be appreciated for thermal uniformity. However, it is such a thin film that thermal conductivity little improves as a thin film on a member. Even in this sense, it is considered that thermal uniformity is mainly improved not by high thermal conductivity but by the microscopic recesses and projections of the diamond film.

As a method of forming the diamond thin film, for instance, CVD, PVD, hot-filament method, arc jet method, and so forth are included. The adhesion strength is 15 MPa or more, more preferably, 20 MPa or more. As long as high corrosion-erosion resistance may be obtained, any method is applicable. The most preferable method is CVD since the method can provide preferable microscopic recesses and projections with few non-diamond components, and can ensure sufficient adhesion strength.

The diamond-coated corrosion-erosion resistant member of the present invention is used for a substrate treating device. By coating at least parts facing a substrate with a diamond thin film, excellent corrosion-erosion resistance can be provided.

Subsequently, a diamond-coated heater will be explained below.

The present inventors found that coated diamond has some conductivity in accordance with the measurement of electric resistivity of a diamond thin film. Generally, diamond is known as an insulating material. It is known that diamond to which boron is doped, has exceptional conductivity. However, boron is an element to form a P-type semiconductor, and should be strictly controlled in semiconductor producing processes. Thus, the diffusion of boron to a substrate, such as a silicon wafer, has to be avoided since it provides significant effects on device characteristics. The reason why conductivity is added to a diamond thin film, either the coating method or stress inside the film due to a difference in thermal expansion with a basal material, is unclear. However, this indicates that electric charge is not generated even when a diamond-coated surface is exposed to plasma, providing excellent advantages such as no danger of damaging a device, and so forth. This characteristic may be highly preferable since a heater that is perfectly integrated and yet can maintain an electric floating state between a heater element and a chamber and can release only surface charge, may be provided by combining an insulating basal material and the embedded heater element. Incidentally, a diamond film having conductivity is applicable as a high-frequency electrode or a direct current electrode for giving bias. Even if a diamond film does not have conductivity, it is applicable as one of these electrodes by being coated on a conductive material.

The light permeability of a diamond thin film is also a preferable characteristic in the application to a heater. For instance, a heater installed in a semiconductor producing apparatus such as a CVD apparatus, is often used under reduced pressure rather than atmospheric pressure, so that it is important to control the emissivity of a heater material in order to ensure the thermal uniformity of a substrate. When a surface layer does not permit light permeation, in other words, when a surface layer itself controls emissivity, it will be difficult to uniformly control film properties. Additionally, since emissivity also normally relies on a film thickness or wavelength, thermal uniformity will be uneven. Diamond easily lets light, in other words, heat ray can permeate easily therethrough, so that stable thermal uniformity may be provided by controlling the emissivity of a basal material. In the case that the diamond thin film has translucent, it is also possible to design a diamond film so that variance in emissivity of a basal material is controlled in addition to the aforementioned advantage. In this respect, a colored and transparent diamond film is preferable. If a basal material were made of polycrystalline ceramics, emissivity would be relatively easily controlled since scattering effects at a grain boundary of crystals, in addition to emission from the material itself, also contribute thereto.

The present inventors took advantage of these characteristics, and invented a diamond-coated heater for a substrate treating device mentioned below.

That is, the present invention provides a heater to be installed in a substrate treating device: comprising a basal material having an embedded heater element and an adhered thin film to cover at least parts of the basal material facing a substrate, and heating the substrate, characterized in that the thin film is a diamond film in which a main crystal phase is diamond, and adhesion strength between the thin film and the basal material is 15 MPa or more.

As described above, the cost-balance becomes possible when diamond is used as a surface-adhered thin film. In applying a diamond film as an adhered thin film, adhesion strength to the basal material relates to thermal barriers at an interface between the diamond thin film and the basal material and is important in the aspect of heater characteristics such as heating efficiency and thermal uniformity. The film may not peel off by thermal stress during a high-temperature retention process or a temperature rise and fall process, or by the growth stress of film forming materials in case of application to a film forming heater for use in a CVD apparatus, PVD apparatus and so forth. After thorough examination of these conditions, the present inventors found that it is important to have adhesion strength of 15 MPa or more between the diamond thin film and the basal material in the diamond-coated heater. More preferably, the adhesion strength thereof is 20 MPa or more.

In the diamond-coated heater of the present invention, the basal material preferably has high thermal conductivity. The thermal conductivity is preferably 50 W/mK or more when expressed in relatively measurable room temperature values. At least one member of a metal material or a compound material selected from the group consisting of, for example, silicon carbide, metal silicon, silicon nitride, aluminum nitride and boron nitride, may be preferably used. Diamond or highly thermally conductive silicon nitride ceramics are also applicable. Furthermore, as a basal material, it is also preferable to use single crystal silicon. The thermal conductivity is more preferably 80 W/mK or more in room temperature values.

In case of a heater having an embedded heater element, it is preferable to use a basal material having high electrical resistance; thus, it is preferable to use any one of the ceramics capable of meeting this condition selected from aluminum nitride, boron nitride and silicon nitride. A structure having a heating mechanism inside the basal material is also preferable for a heater having a non-embedded heater element. Auxiliary agents may be added to the ceramics applied to the basal material. When the basal material is aluminum nitride, the material may contain, for example, alkaline earth, rare earth, lithium or the like as an auxiliary agent.

A coated area ratio of a thin film relative to a surface area of the basal material of the diamond-coated heater may be 100%, that is, the whole surface may be coated; but is preferably 10 to 90%, more preferably, 60 to 80%. It is also preferable to interpose at least one member of a metal material or a compound material selected from the group consisting of, for example, silicon carbide, silicon nitride, silicon, carbon, tungsten and molybdenum between the basal material and the thin film. The improvement of adhesion strength may be expected from the formation of the intermediate layer thereby, as in case of the above-mentioned diamond-coated corrosion-erosion resistant member. The film is also effective for easily controlling the deposition of diamond. The intermediate layer may be formed by a well-known method as long as adhesion strength of 15 MPa or more, more preferably, 20 MPa or more is obtained. The methods include CVD, PVD, plasma-spraying, baking of paste or slurry, and so forth.

In the diamond-coated heater of the present invention, the total weight of group 1a to group 3b elements contained in the thin film is preferably 50 one millionth or less of the total weight of the thin film in order to prevent the film from contamination with metal. The exemplary elements of the group 1a to the group 3b are the same as those for the above-mentioned diamond-coated corrosion-erosion resistant member. Impurities may be similarly analyzed by, for instance, GD-MASS after separating only the diamond film. It is also preferable to dope nitrogen or fluorine to diamond from which the thin film is formed, since corrosion-erosion resistance improves. Further, a diamond for forming a film may contain about 0.01-10 mass % of silicon since resistance to plasma improves.

In the diamond-coated heater of the present invention, corrosion loss due to 400° C. biased nitrogen trifluoride plasma of the thin film is preferably 5 mg/cm²·h or less. It is also preferable that the thin film of the diamond-coated heater comprises a plurality of diamond films having different electric resistivity. For instance, it is preferable that the diamond thin film is not a single layer but a multilayer. As in the diamond-coated corrosion-erosion resistant member mentioned above, when an outermost layer is a low resistance layer and an innermost layer is a high resistance layer, effects such as insulation from the substrate while prohibiting electrification, and so forth may be found. Also, with a multilayer structure, deterioration may be detected. A multi-layered diamond film is preferably obtained through several film-forming steps wherein a gas composition, temperature, plasma power, and the like are successively changed like the aforementioned diamond-coated corrosion-erosion resistant member.

In the diamond-coated heater of the present invention, the microscopic recesses and projections of the diamond film result in the improvement of thermal uniformity as in the case of the diamond-coated corrosion-erosion resistant member mentioned above. Thus, the surface roughness of the diamond thin film is preferably 1 to 100 μm, more preferably, 3 to 10 μp. The thickness of the thin film is preferably 1 to 500 μm in consideration of the balance between corrosion-erosion resistance and costs. Diamond has high thermal conductivity, and this characteristic should be appreciated for thermal uniformity. However, it is such a thin film that thermal conductivity does not improve much as a thin film formed on a heater. In calculation with, for instance, 0.1 mm in thickness of the diamond thin film having thermal conductivity of 1000 W/mK, 5 mm in thickness between the heater element and the diamond thin film and with a silicon nitride basal material having the thermal conductivity of 30 W/mK, the total thermal conductivity λt should be calculated from the following formula:

dt/λt=d diamond/λdiamond+d silicon nitride/λsilicon nitride

This gives the thermal conductivity λt of only 30.6 W/mk. Accordingly, it is considered that thermal uniformity improves by forming a diamond thin film because, for instance, microscopic unevenness, due to the presence of a grain boundary phase or the like in the basal material, is reduced mainly by the irregular reflections of heat rays at microscopic recesses and projections.

In order to form microscopic recesses and projections with such effect in the thin film, it is preferable to provide the diamond thin film by CVD on a substrate face. Plasma CVD is particularly preferable. This is because recesses and projections are formed at a surface since diamond crystals have idiomorphic faces. When the recesses and projections are excessive, thermal transmission efficiency declines, so that about 100 μm or less is preferable in surface roughness. On the contrary, when the surface is too smooth, heat transmission efficiencies become too different between parts where the diamond thin film is contacting and is not contacting. Thus, a certain degree of roughness is preferable. The roughness of the diamond thin film is preferably about 1 μm or more in surface roughness.

As other methods of forming the diamond thin film, PVD, for instance, is included. However, in PVD, a non-diamond component such as DLC (Diamond Like Carbon) increases. In the hot-filament method, filament components are mixed into the diamond thin film. The arc jet method is also unlikely to provide adhesion, and the corrosion-erosion resistance of a diamond thin film seems inferior. However, even those methods may be applied as long as adhesion strength to a substrate is 15 MPa or more, more preferably, 20 MPa or more, and the thin film formed thereby has high corrosion-erosion resistance.

In the diamond film of the diamond-coated heater of the present invention, the degree of orientation of diamond {220} plane in faces parallel to the substrate is within the range expressed by the following formula:

[Im220/(Im220+Im111)]/[Ip220/(Ip220+Ip111)]<1.

Thus, resistance against corrosive gases or plasma may further improve even at a corrosive high temperature. The degree of orientation is more preferably 0.75 or less. Additionally, what is meant by this formula is the same as the case in the diamond-coated corrosion-erosion resistant member mentioned above.

As types of heaters suitable for the diamond-coated heater of the present invention, for instance, a current carrying heating type, in other words, resistance heating type, or a lamp type and so forth may be included. More specifically, as the current carrying heating type, an all-ceramic type with shaft may be included. This type is preferable since it has no metal parts at locations exposed to process gas or cleaning gas, particularly, at temperature-rising locations.

The diamond-coated heater of the present invention may be obtained by co-sintering molybdenum, tungsten or the like to embed a heater element in one body with a basal material as shown in JP-B-6-28258 and JP-B-8-8215 as an example. A metal wire should be used for the heater element to permit heavy-current flow, but powder paste may also be applied. In the type for embedding a heater element in a basal material, heat is transmitted to the basal material, so that heating efficiency becomes high. However, the basal material, at the same time, should have a volume resistivity at a certain level or more in order to provide electric insulation between elements and between an element and an earth. The volume resistivity is 1×10⁴ Ωcm or more in operating temperature as a target, and is preferably 1×10⁶ Ωcm or more in operating temperature. In this sense, it is preferable to use ceramics such as aluminum nitride, boron nitride and silicon nitride for the basal material. In case of applying the so-called sheath type heater element, there is no limitation on electric resistance, and silicon carbide is also applicable.

The diamond-coated heater of the present invention may be used not only as a mere heater but also as a heater combined with a high frequency electrode, or a heater having chuck functions such as a susceptor and a vacuum chuck. Additionally, the techniques of conventional material, the techniques for jointing, the techniques of designing are applicable to the heater.

It is possible to give corrosion-erosion resistance to a ring, which is exposed to a harsh corrosive environment as with the heater mentioned above, by forming a diamond thin film. The ring herein is a part that is located at the outer circumference of a substrate to surround the substrate. The diamond-coated ring will be explained below.

According to the present invention, is provided a diamond-coated ring being installed in a substrate treating device, mainly, an etcher, and a thin film thereof being a diamond film having diamond as a main crystal phase, characterized in that the adhesion strength between the thin film and a basal material is 15 MPa or more.

Similar to the case of the diamond-coated heater described above, it will be possible to balance its use with its economics when diamond is used as a surface-adhered thin film. When a diamond film is applied as an adhered thin film, adhesion strength to the basal material interacts with thermal barriers at an interface between the diamond thin film and the basal material, and therefore is important from the standpoints of heating efficiency, thermal uniformity and so forth. The film is required not to peel off by steady and unsteady thermal stress due to the on/off effect of plasma, or by the deposition stress of reaction by-products in an etching process. The present inventors have found that it is important to have adhesion strength of 15 MPa or more between the diamond thin film and the basal material even in the case of the diamond-coated ring after the thorough examination of these conditions. The adhesion strength is more preferably 20 MPa or more.

In the diamond-coated ring of the present invention, the basal material preferably has high thermal conductivity. The thermal conductivity is preferably 50 W/mK or more when expressed in relatively measurable room temperature values. At least one member of a metal material or a compound material selected from the group consisting of, for example, silicon carbide, metal silicon, silicon nitride, aluminum nitride and boron nitride, may be preferably used. Diamond or highly thermally conductive silicon nitride ceramics are also applicable. As a basal material, it is also preferable to use single crystal silicon. The thermal conductivity is more preferably 80 W/mK or more in room temperature values.

When the ceramics such as silicon nitride, aluminum nitride, boron nitride or the like is used, the auxiliary agents may be contained. If aluminum nitride is used as a basal material, it may contain, for example, alkaline earth, rare earth, lithium or the like as an auxiliary agent.

A coated area of a thin film relative to a surface area of the basal material in the diamond-coated ring is preferably 10 to 90%, more preferably, 60 to 80%. It is also preferable to include at least one member of a metal material or a compound material selected from the group consisting of silicon carbide, silicon nitride, silicon, carbon, tungsten and molybdenum between the basal material and the thin film. The improvement of adhesion strength may be expected from the formation of the intermediate layer therefrom, similar to the above-mentioned diamond-coated corrosion-erosion resistant member. Furthermore, the deposition of diamond may be controlled easily therefrom. The intermediate layer may be formed by a well-known method as long as adhesion strength of 15 MPa or more, more preferably, 20 MPa or more is attainable. The methods include CVD, PVD, plasma-spraying, baking of paste or slurry, and so forth.

In the diamond-coated ring of the present invention, the total weight of the elements of the group 1a to the group 3b contained in the thin film is preferably 50 one millionth or less of the total weight of the thin film in order to prevent the film from metal contamination. The exemplary elements of the group 1a to the group 3b are the same as those for the above-mentioned diamond-coated corrosion-erosion resistant member. Impurities may be similarly analyzed by, for instance, GD-MASS after separating only the diamond film. It is also preferable to dope nitrogen or fluorine to diamond from which the thin film is formed, since corrosion-erosion resistance improves. Further, a diamond to form a film may preferably contain about 0.01-10 mass % of silicon since resistance to plasma improves.

In the diamond-coated ring of the present invention, corrosion loss of the thin film due to 400° C. biased nitrogen trifluoride plasma is preferably 5 mg/cm²·h or less. It is also preferable that the thin film of the diamond-coated ring is composed of a plurality of diamond films having different electric resistivity. For instance, it is preferable to form the diamond thin film of not a single layer but a multilayer. When an outermost layer is a low resistance layer and an innermost layer is a high resistance layer, effects such as insulation from the substrate while prohibiting electrification, and so forth may be attained, similar to the case of the diamond-coated corrosion-erosion resistant member mentioned above. Also, with a multilayer structure, deterioration may be detected. Further, A multi-layered diamond film is preferably obtained through several film-forming steps wherein a gas composition, temperature, plasma power, and the like are successively changed like the aforementioned diamond-coated corrosion-erosion resistant member.

In the diamond-coated ring of the present invention, the microscopic recesses and projections of the diamond film result in the improvement of thermal uniformity and adhesion of depositing by-products as in the diamond-coated corrosion-erosion resistant member mentioned above. Thus, the surface roughness of the diamond thin film is preferably 1 to 100 μm, more preferably, 3 to 10 μm. The thickness of the thin film is preferably 1 to 500 μm in consideration of the balance between corrosion-erosion resistance and costs. Diamond has high thermal conductivity, and this characteristic should be appreciated for thermal uniformity. However, it is such a thin film that thermal conductivity does not improve much as a diamond film formed on a ring. Accordingly, it is considered that thermal uniformity improves by forming a diamond thin film because, for instance, microscopic unevenness, due to a grain boundary phase or the like in the basal material, is reduced mainly by the irregular reflections of heat rays at microscopic recesses and projections.

In order to form microscopic recesses and projections having such effect in the thin film, it is preferable to provide the diamond thin film by CVD on a substrate face. Furthermore, plasma CVD is particularly preferable. This is because recesses and projections are formed at a surface because diamond crystals have idiomorphic faces. When the recesses and projections are excessive, thermal transmission efficiency declines, so that about 100 μm or less is preferable in surface roughness. On the contrary, when the surface is too smooth, heat transmission efficiencies become too different between parts with and without the diamond thin film. Thus, a certain degree of roughness is desirable. The roughness of the diamond thin film is preferably about 1 μm or more in surface roughness.

As other methods of forming the diamond thin film, PVD, hot-filament method, arc jet method, and so forth are included. Even those methods are applicable as long as adhesion strength is 15 MPa or more, more preferably, 20 MPa or more, and the thin film formed thereby has high corrosion-erosion resistance.

In the diamond film of the diamond-coated ring of the present invention, if the degree of orientation of diamond {220} plane in faces parallel to the basal material is formed within the range expressed by the following formula:

[Im220/(Im220+Im111)]/[Ip220/(Ip220+Ip111)]<1,

resistance against corrosive gases or plasma may further improve under a more corrosive condition at a high temperature. The degree of orientation is more preferably 0.75 or less. Additionally, what is meant by this formula is the same as the case in the diamond-coated corrosion-erosion resistant member mentioned above.

Corrosion-erosion resistance can be imparted also to a susceptor, which is exposed to a severe corrosion-erosion environment like the aforementioned heater and ring. Herein, a susceptor means a stand for mounting a substrate thereon and includes an electrostatic chuck and a high-frequency electrode in the lower portion. A diamond-coated susceptor is hereinbelow described.

According to the present invention, there is provided a diamond-coated susceptor being installed in a substrate treating device, comprising a basal material and an adhered thin film for coating at least a part of the basal material facing a substrate, and preferably having an electrode between the basal material and the thin film; characterized in that the thin film is a diamond film of which main crystal phase is diamond, and that adhesion strength between the thin film and the basal material is 15 MPa or more. The electrode may be present on the whole interface between the basal material and the diamond film. However, it is preferable that the electrode is present on a part of the interface between the basal material and the diamond film. This is because a current value of leakage from the electrode to a treating device can be easily set to be a desired value as mentioned later.

The usage of a diamond as a thin film adhering on a surface is compatible with economical efficiency like the aforementioned cases of a heater and a ring. In the case of applying a diamond film as an adhering thin film, adhesion strength is important so as not to exfoliate the diamond thin film from the basal material even adsorption and desorption of a substrate of Si wafer or the like are repeated. According to the results of keen investigation by the present inventors, it is important that adhesion strength between the diamond film and the basal material is 15 MPa or more in a diamond-coated susceptor, and the adhesion strength is more preferably 20 MPa or more.

In a diamond-coated susceptor of the present invention, a basal material has preferably high thermal conductivity, preferably a thermal conductivity of 50 W/mK or more in terms of a value at room temperature, which can be relatively easily measured. A more preferable thermal conductivity is 80 W/mK or more in terms of a value at room temperature. There may be suitable employed, as a basal material, at least one selected from the group consisting of silicon carbide, aluminum nitride and boron nitride to satisfy the condition. Alternatively, a silicon nitride ceramic having high thermal conductivity is applicable. When a ceramic is used as a basal material, it may contain a sintering aid. If aluminum nitride is employed as the basal material, it may contain, as an aid, an alkaline earth metal, a rare earth element, or a compound of lithium or the like, or an oxide in most cases.

In addition, a basal material is required to have a certain volume resistivity or higher. The volume resistivity is preferably 1×10⁶ Ωcm (1MΩcm) or more, more preferably 1×10⁸ Ωcm or more, within the temperature range for use so as to realize a desired low leak current. Also from the view of this condition, the aforementioned materials are suitable as the basal material.

Incidentally, an electrode may be structured so that a metallic bare wire is embedded in the form of mesh in a ceramic material. The electrode can be employed also as a high-frequency electrode because a large current can be sent since such a structure has low electric resistance as an electrode.

It is also preferable that the electrode is constituted by a composite obtained by co-sintering a ceramic material and a metallic material. If tungsten, molybdenum, or alloy containing them, or a carbide thereof is used as the metallic material in this case; the layer functions also as an intermediate layer to improve adhesion.

In a diamond-coated susceptor of the present invention, total weight of the elements of the groups 1a-3b contained in a thin film is preferably 50 millionth or less of the whole weight of the thin film for the purpose of avoiding metal contamination. Details of the elements of the groups 1a-3b are the same as in the case of the aforementioned diamond-coated corrosion-erosion resistant member. Impurities can be analyzed in, for example, the GD-MASS method by cutting off only the diamond film in the same manner. In addition, it is preferable to dope nitrogen or fluorine to diamond for forming the thin film since erosion resistance improves. Further, the diamond for forming a film may contain about 0.01-10 mass % of silicon since resistance to plasma improves.

In a diamond-coated susceptor of the present invention, corrosion loss of the thin film due to 400° C. biased nitrogen trifluoride plasma is preferably 5 mg/cm²·h or less.

In a diamond-coated susceptor of the present invention, the thin film preferably comprises a plurality of diamond films having different electric resistivity to aim to improve adsorption properties and reduce a leak current. For instance, when the diamond thin film has not a single layer structure but a multilayer structure, and has a high resistance layer as an outermost layer (a substrate side) and a low resistance layer as an innermost layer (an electrode or basal material side), adhesion properties are improved; and adhesion is improved by further thinning the high resistance. These multi-layered diamond films can be obtained through several film-forming steps. At this time, the films are preferably formed with a gas composition, temperature, plasma power and the like being successively changed in every step because bonding force between the layers can be further enhanced.

In the diamond-coated susceptor of the present invention, surface roughness of the thin film is preferably about 1 to 100 μm because the microscopic recesses and projections of the diamond film improves thermal uniformity like the aforementioned diamond-coated corrosion-erosion resistant member. More preferably, the surface roughness of the thin film is about 3 to 10 μm. In addition, the thickness of the diamond thin film is preferably 1 to 500 μm in consideration of the balance between costs and corrosion-erosion resistance.

A diamond thin film formed on the side of the substrate is preferably formed in the CVD method, particularly the plasma CVD method, in order to impart the microscopic recesses and projections which produce such effect to the thin film. This is because the microscopic recesses and projections are formed since diamond crystals present their own forms on the surface. If the recesses and projections are excessive, efficiency in heat transmission is lowered. Therefore, the recesses and projections are about 100 μm or less in terms of surface roughness. If the surface is too flat and smooth, efficiency in heat transmission differs too much between a portion where a diamond film contacts the surface and a portion where a diamond film does not contact the surface. Therefore, the surface is preferably rough to a certain degree.

There is the PVD method alternatively as a method for forming a diamond thin film. In the PVD method, nondiamond components of, for example, DLC (Diamond Like Carbon) increase. In the heat filament method, a filament component is mixed in the diamond thin film. In the arc-jet method, adhesion is week, and corrosion-erosion resistance of the diamond thin film shows up badly in comparison. However, even these methods are applicable as long as adhesion strength between the diamond thin film and the substrate is 15 MPa or more, preferably 20 MPa or more, and the thin film obtained has high corrosion-erosion resistance.

In the diamond film of the diamond-coated susceptor of the present invention, the degree of orientation of diamond {220} plane in faces parallel to the substrate is within the range expressed by the following formula:

[Im220/(Im220+Im111)]/[Ip220/(Ip220+Ip111)]<1.

Thus, resistance against corrosive gases or plasma may further improve even at a corrosive high temperature. The degree of orientation is more preferably 0.75 or less. Additionally, what is meant by this formula is the same as the case in the diamond-coated corrosion-erosion resistant member mentioned above.

According to the present invention, there is further provided a method for producing a diamond-coated susceptor being installed in a substrate treating device, comprising a basal material and an adhered thin film for coating at least a part of the basal material facing a substrate, and having a metal-containing electrode interposed between the basal material and the thin film, to mount the basal material thereon; the method comprising the steps of: embedding the electrode in the basal material with molding the basal material, co-sintering the basal material and the electrode, machining-removing a surface of the basal material to expose the electrode to the surface of the basal material, followed by forming a diamond film on the surface of the basal material, imparting high electric resistance to the diamond film by a plasma treatment, and connecting a terminal to the electrode. Incidentally, the metal-containing electrode can have two modes. One electrode is of a metallic material itself. At this time, the electrode is constituted so that a metallic bare wire is disposed in the form of mesh in a basal material, which is a ceramic material in most cases. If the ceramic material is the same material as the basal material, the electrode is embedded in the basal material on the side of the diamond film instead of covering the whole surface of the basal material. The other electrode can be constituted as a composite where a ceramic material and a metallic material are co-sintered. At this time, the electrode functions also as an intermediate layer to improve adhesion strength between the basal material and the diamond film.

### BRIEF DESCRIPTION OF THE DRAWINGS

FIG. 1(a) to FIG. 1(c), FIG. 2(a) to FIG. 2(c), FIG. 3(a) to FIG. 3(c), FIG. 4(a) to FIG. 4(c) are figure-substituting photographs in which facets before and after tests are enlarged by SEM (Scanning Electron Microscope) in the diamond-coated corrosion-erosion resistant member relating to the present invention.

FIG. 5 is a cross section, showing an embodiment of a semiconductor producing apparatus that has a built-in heater for heating a substrate and consists of conventional members.

FIG. 6 is a cross section, showing another embodiment of a semiconductor producing apparatus that has a built-in heater for heating a substrate and consists of conventional members.

FIG. 7(a), FIG. 7(b) are cross sections, showing one embodiment of a diamond-coated heater relating to the present invention.

FIG. 8 is a cross section, showing another embodiment of the diamond-coated heater relating to the present invention.

FIG. 9 is a figure, showing one embodiment of a member for use in a semiconductor producing apparatus having a heater for heating a substrate, and is a perspective view of a ring.

FIG. 10 is a cross section, showing another embodiment of the diamond-coated heater relating to the present invention.

FIG. 11 is a graph, showing one embodiment of the Raman spectrum according to the Raman spectroscopy.

FIG. 12 is a sectional view showing an embodiment of a diamond-coated susceptor of the present invention.

FIG. 13 is a sectional view showing another embodiment of a diamond-coated susceptor of the present invention.

FIG. 14 is a sectional view showing still another embodiment of a diamond-coated susceptor of the present invention.

FIGS. 15(a)-15(e) are explanatory views showing an embodiment of a method for producing a diamond-coated susceptor of the present invention.

### DESCRIPTION OF THE PREFERRED EMBODIMENT

The embodiments of the present invention will be explained by referring to the drawings.

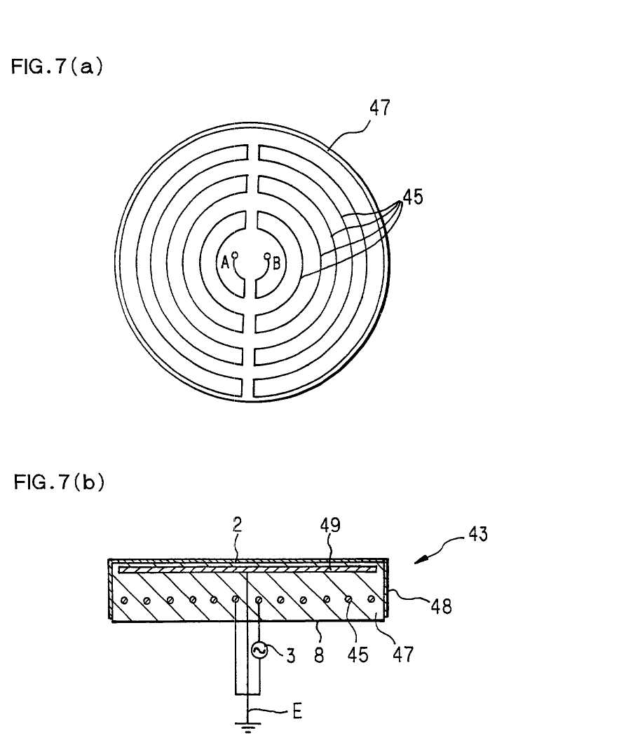

FIG. 7(a), FIG. 7(b) are cross sections, showing one embodiment of a diamond-coated heater according to the present invention. FIG. 7(a) shows a cross section in a horizontal direction, and FIG. 7(b) shows a cross section in a perpendicular direction. As shown in FIG. 7(b), a diamond film 48 is coated on a heating face 2 and a side face of a basal material 47 of a diamond-coated heater 43. In the basal material 47 of the diamond-coated heater 43, a coiled resistance heater element 45 and a high frequency electrode 49 are embedded. The resistance heater element 45 is embedded at the side of a back face 8, and the high frequency electrode 49 is embedded at the side of the heating face 2.

A plan figure of the embedded resistance heater element 45 is shown schematically in FIG. 7(a). In other words, for instance, a molybdenum wire is wound to provide a wound body, and terminals A, B are bonded to both ends of the wound body. The resistance heater element 45 is arranged horizontally as shown in FIG. 7(b), and is arranged to draw concentric circles with different diameters as a whole and to be almost symmetric with respect to a line as shown in FIG. 7(a). An alternating-current power source 3 for electrifying and heating is connected to the resistance heater element 45, and is also connected to an earth E. The high frequency electrode 49 is also connected to the earth E as an anode electrode.

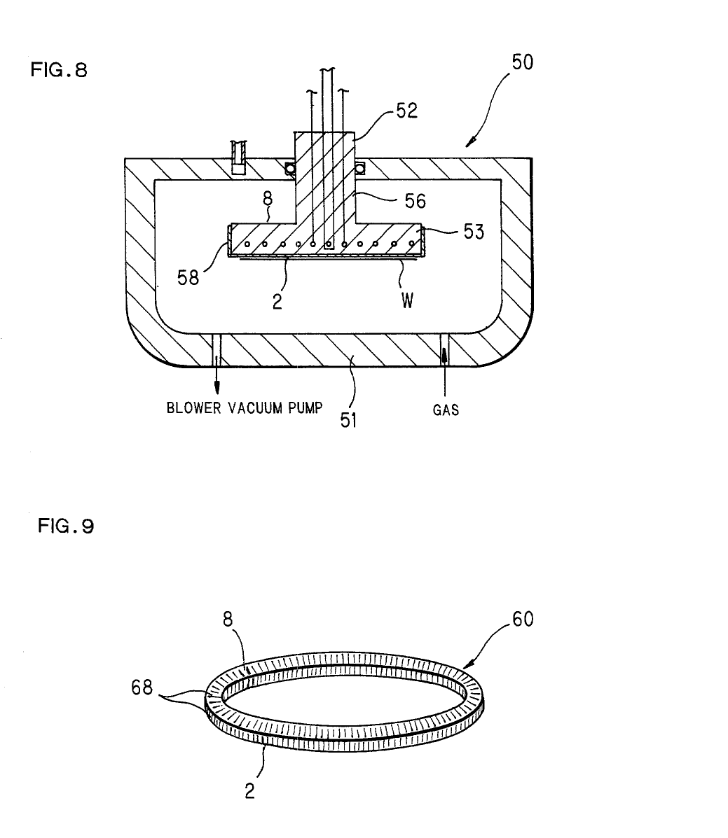

FIG. 8 is a cross section, showing another embodiment of the diamond-coated heater according to the present invention. As shown in FIG. 8, a CVD apparatus 50, as one of semiconductor substrate treating devices, has a disc-like heater 53 through a supporting member 56 inside a reactor 51, and has a built-in heating device 52 for heating a substrate W. FIG. 8 shows a mechanism of fixing the substrate on the lower surface of the heater with a mechanical cramp so as to prevent the substrate from falling. However, it is also possible to separately dispose a susceptor in the lower part of the heater to heat the substrate from the above heater. Gas for CVD is supplied into the reactor 51, and the disc-like heater 53 and the supporting member 56 are exposed to corrosive atmosphere. However, a diamond film 58 is coated on a heating face 2 and side faces of the disc-like heater 53, thus, it is protected from corrosion-erosion, and resultantly it does not become an impurity source.

FIG. 9 is a figure, showing one embodiment of a member for use in a semiconductor producing apparatus, particularly, an etching apparatus, and is a perspective view of a ring 60. Or, like a CVD apparatus 34 shown in FIG. 6, it may be used as a supporting member 36 in a heating device 32 having a space at the back face of a disc-like heater 33. Members around a substrate, like the heater, are exposed to a corrosive atmosphere, and should be corrosion-erosion resistant. The ring 60 applied for such a purpose, is coated with a diamond film 68 at a heating face 2 and inner and outer side faces, thus it is protected from corrosion-erosion.

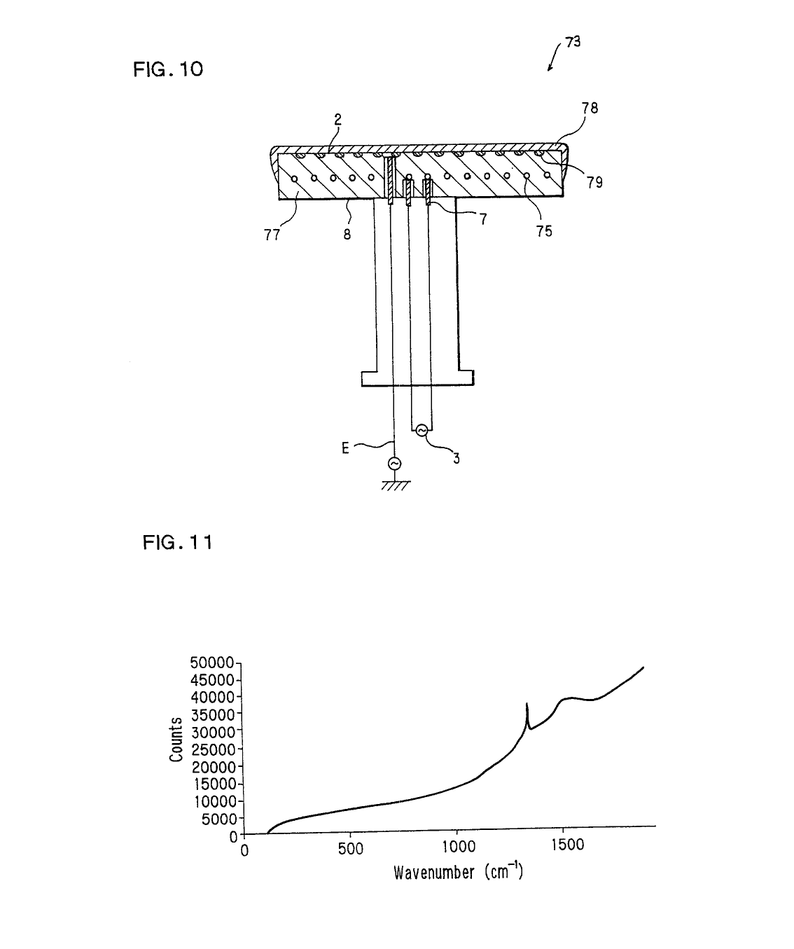

FIG. 10 is a cross section, showing another embodiment of the diamond-coated heater according to the present invention. As shown in FIG. 10, a diamond film 78 is coated on a heating face 2 and side faces of a basal material 77 of a diamond-coated heater 73. In the basal material 77 of the diamond-coated heater 73, a coiled resistance heater element 75 and a flat mesh-shaped high frequency electrode 79 are also embedded. The resistance heater element 75 is embedded at the side of the back face 8, and the high frequency electrode 79 is embedded at the side of the heating face 2. The high an alternating-current power source 3 for electrifying and heating is connected to the resistance heater element 75, and the high frequency electrode 79 is connected to an earth E as an anode electrode.

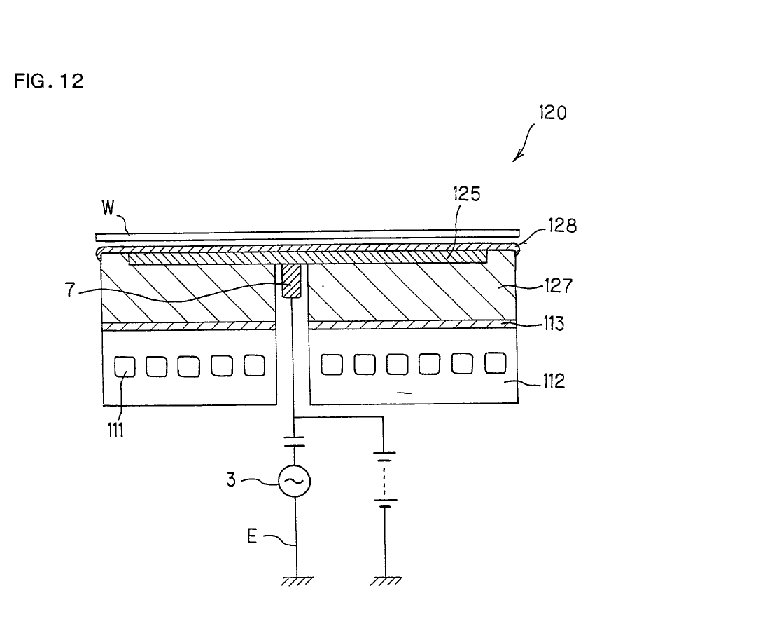

FIG. 12 is a sectional view showing an embodiment of a diamond-coated susceptor of the present invention. The diamond-coated susceptor 120 employs, as the electrode 125, a composite obtained by co-sintering a metallic material (powder) and a ceramic material (powder). Though this composite is an electrode, it is different from the electrode 115 of metallic bare wire described later. The electrode 125 is designed as a monopole type of electrostatic chuck and high-frequency electrode. The electrode 125 is not provided on the whole upper surface of the basal material 127 to be coated with the diamond film 128, and the basal material 127 is left without being coated at the peripheral portion with a width of 5-10 mm or around, for example, a gas hole and a lift pin hole. Use of a ceramic material having a high electric resistivity of 1×10⁸ Ωcm or more can reduce a leak current and control potential of the susceptor and the substrate more precisely. The basal material 127 is connected to a cooling plate 112 of, for example, an aluminum alloy via a connecting layer 113. Though, as the connecting layer 113, there may be employed silicone, polyimide, fluororesin, or metal bonding such as indium; it is not limited to these as long as it has high thermal conductivity.

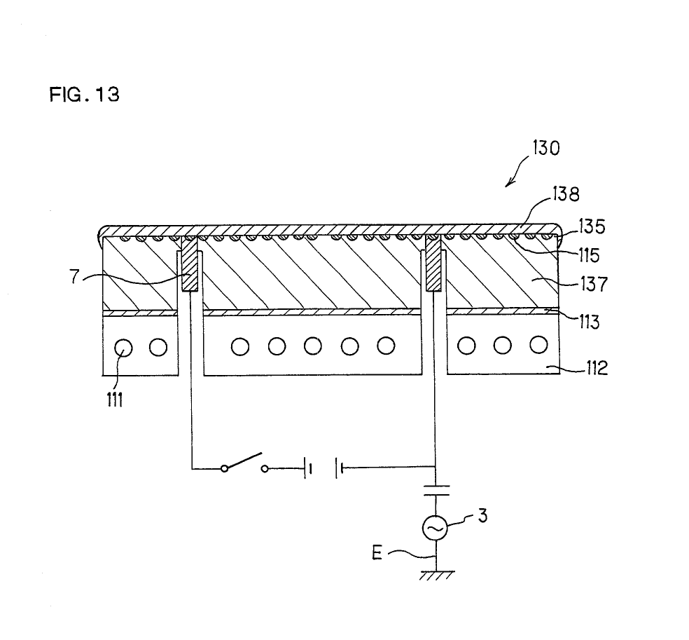

FIG. 13 is a sectional view showing another embodiment of a diamond-coated susceptor of the present invention. In the diamond-coated susceptor 130, a metallic material (electrode 115) is disposed in the form of mesh in a ceramic material, which is the same as the basal material 137 as an intermediate layer 135. That is, in the diamond-coated susceptor 130, metallic bare wire (electrode 115) is disposed in the form of a mesh plane in the basal substrate 137 on the side of the diamond film 138. In the diamond-coated susceptor 130, the electrode 115 is designed as a dipole type of electrostatic chuck electrode. The electrode 115 is not provided on the whole upper surface of the basal material 137 to be coated with the diamond film 138, and the basal material 137 is left without being coated at the peripheral portion with a width of 5-10 mm or around, for example, a gas hole and a lift pin hole. Effect due to use of a ceramic material having a high electric resistivity of 1×10⁸ Ωcm or more, constitution including a connecting layer and a cooling plate, a material for the connecting layer, etc., are in accordance with the diamond-coated susceptor 120.

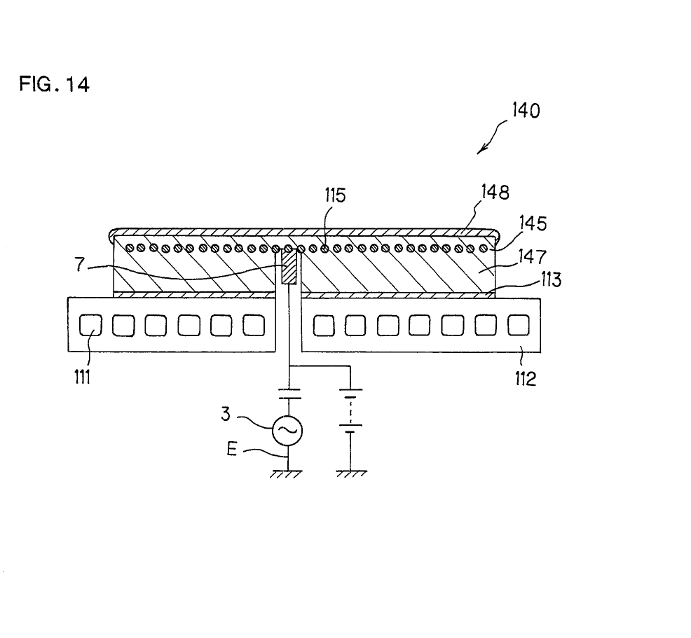

FIG. 14 is a sectional view showing still another embodiment of a diamond-coated susceptor of the present invention. In the diamond-coated susceptor 140, metallic bare wire (electrode 115) is disposed in the form of a mesh plane in a basal material 147. The difference from the diamond-coated susceptor 130 is that the metallic material (electrode 115) does not contact the diamond film and a basal material is interposed. In the diamond-coated susceptor 140, the electrode 115 is designed as a monopole type of electrostatic chuck electrode and high-frequency electrode. The electrode 115 is not provided on the whole upper surface of the basal material 147 to be coated with the diamond film 148, and the basal material 147 is left without being coated at the peripheral portion with a width of 5-10 mm or around, for example, a gas hole and a lift pin hole. Effect due to use of a ceramic material having a high electric resistivity of 1×10⁸ Ωcm or more, constitution including a connecting layer and a cooling plate, a material for the connecting layer, etc., are in accordance with the diamond-coated susceptor 120.

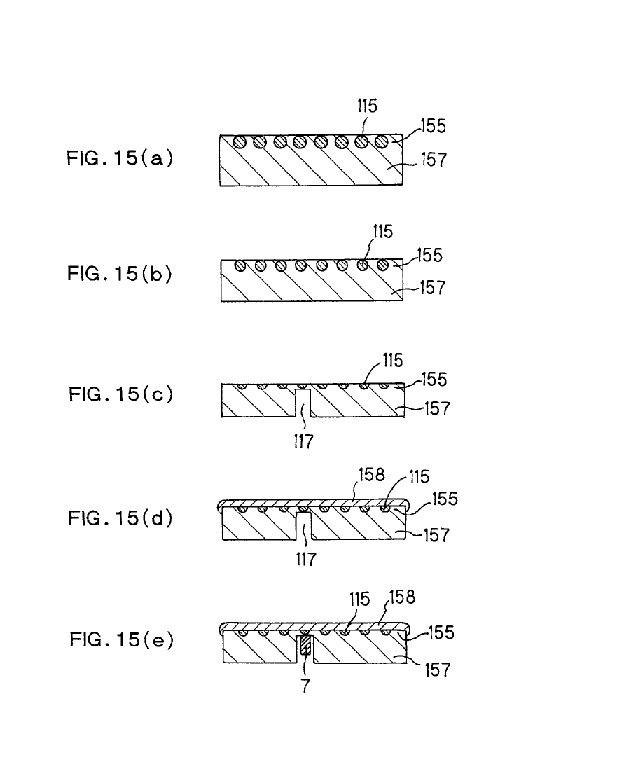

FIGS. 15(a)-15(e) are explanatory views showing an embodiment of a method for producing a diamond-coated susceptor of the present invention. FIG. 15(a) shows a step where the basal material 157 is molded and, at the same time, the electrode 115 is embedded in the basal material 157; FIG. 15(b) shows a step where the basal material 157 having the electrode 115 embedded therein is sintered; FIG. 15(c) shows a step where a surface (on the side of absorbing a substrate) of the basal material 157 is machined to expose the electrode 115 on the surface and where a terminal hole 117 is formed on the surface opposite to the surface where the electrode 115 is exposed; FIG. 15(d) shows a step where a diamond film 158 is formed on a surface where the electrode 115 is exposed and the diamond film 158 is subjected to a plasma treatment to obtain high electric resistance; FIG. 15(e) shows a step where the electrode terminal 7 is metallic-bonded to the electrode 115. Incidentally, in a diamond-coated susceptor shown in FIGS. 15(a)-15(e), “the intermediate layer 155” means a layer including the electrodes 115 and the basal material 157 between the electrodes 115.

### EXAMPLES

Subsequently, the characteristics of the diamond-coated corrosion-erosion resistant member of the present invention will be explained in comparison with a conventional non-diamond-coated member.

### Examples 1-3, Comparative Example 1

A silicon nitride sintered body was prepared by sintering and compacting in nitrogen with strontium carbonate and ceria as sintering aids, and was cut into small pieces of 20 mm W (width)×20 mm L (length)×2 mm t (thickness) shape by using a diamond grinding stone. To the small pieces, a 15 μm-thick diamond film was deposited by microwave CVD using methane, hydrogen, oxygen as a starting gas (Example 1). Basal material temperature was 730° C. during a film forming process. Also, a 3 μm-thick diamond film was deposited by the hot-filament method using methane, hydrogen as a starting gas (Example 2). Basal material temperature was 750° C. Furthermore, a 70 μm-thick diamond film was deposited by the arc jet method using methane, hydrogen as a starting gas (Example 3).

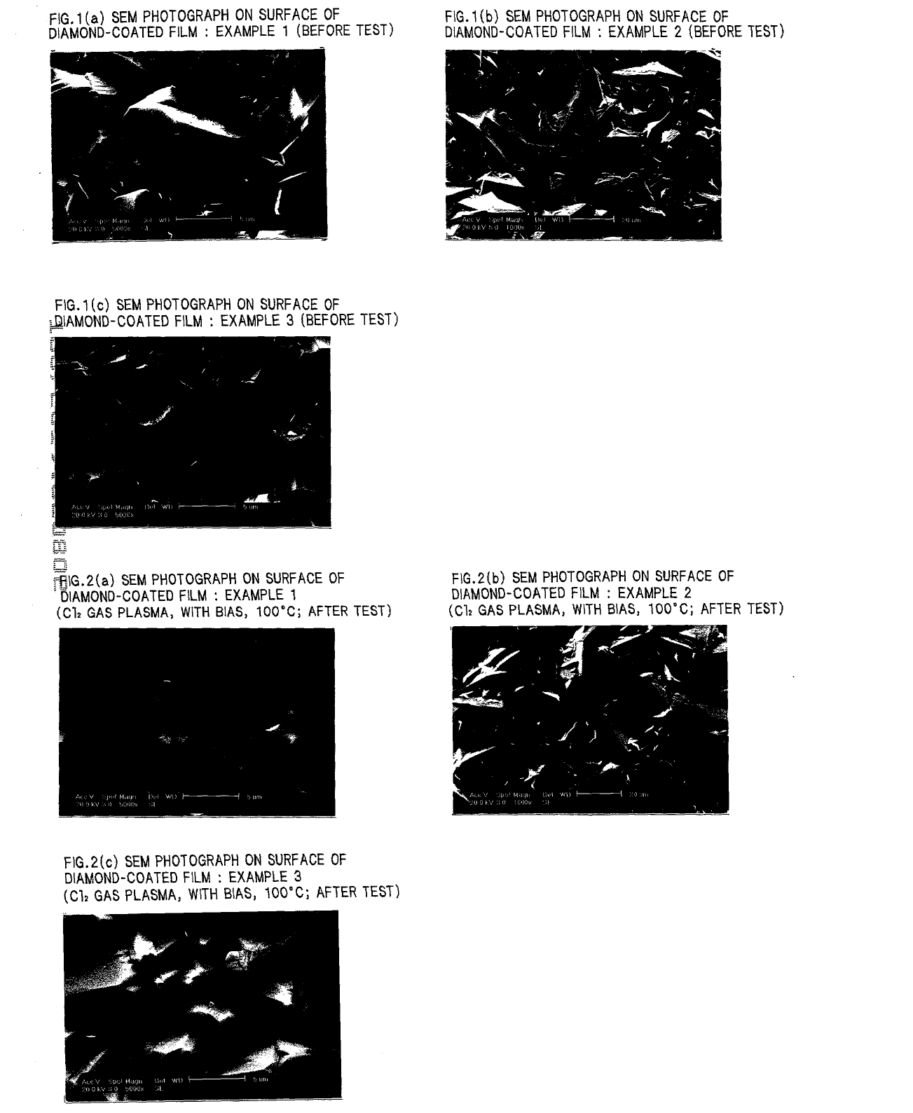

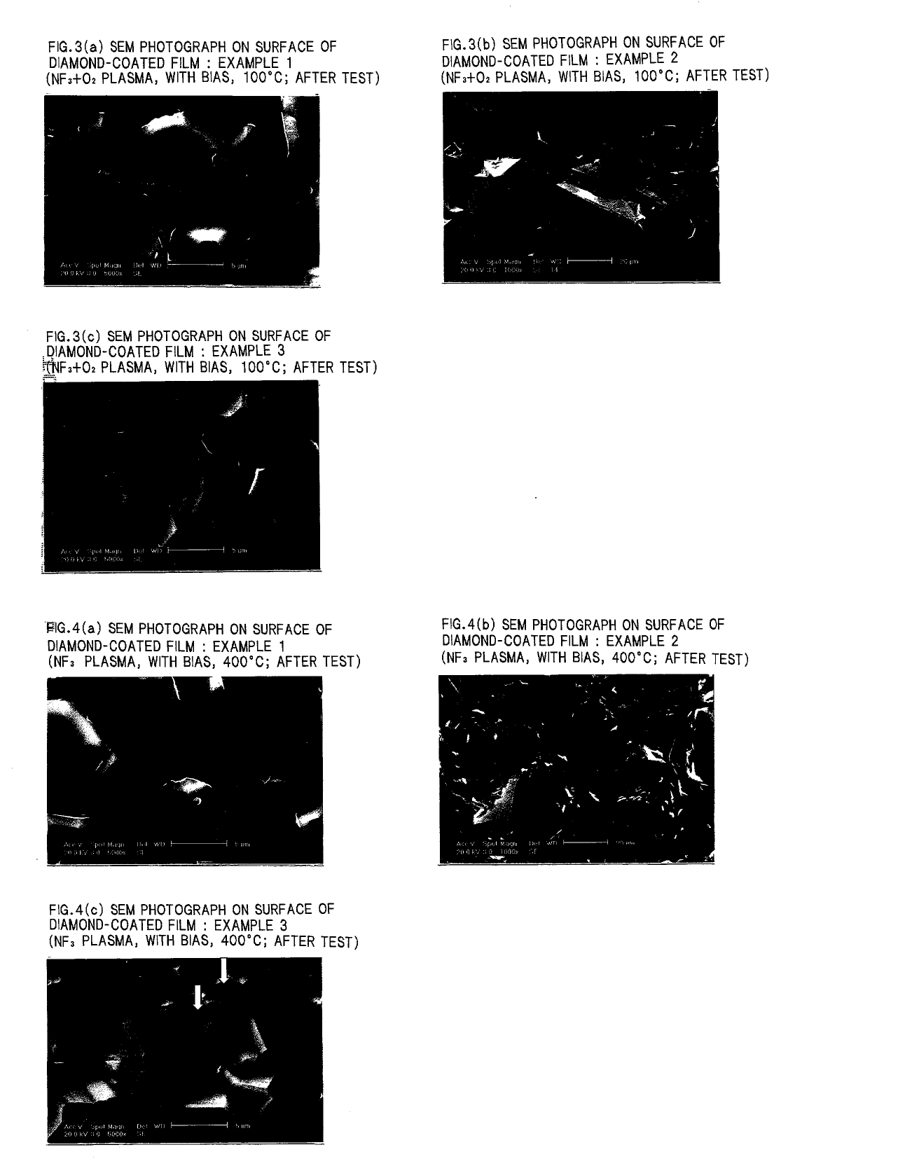

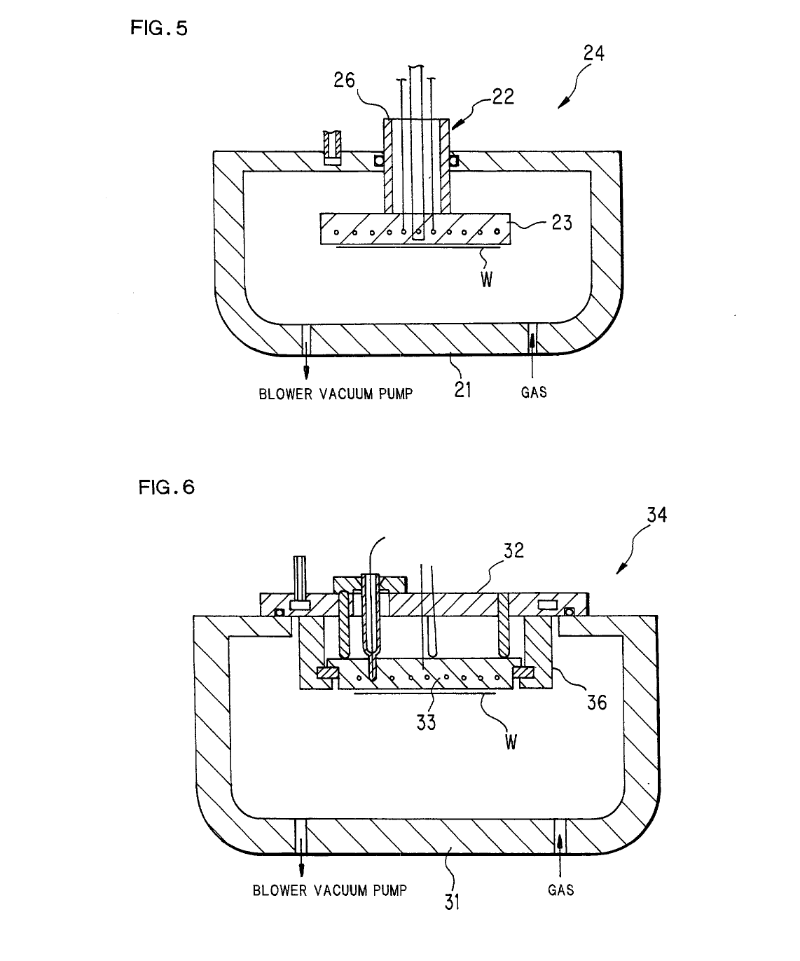

In Examples 1 to 3, a crystal phase consisted of diamond phase and a non-diamond phase, and facets were clearly observed as shown in FIG. 1(a) to FIG. 1(c).

As the characteristics of a surface of the diamond films, a relatively a plenty of facets 100, that is, square faces having 90° angles is recognized in Example 1. However, in Example 2 and Example 3, while there is such a difference in the shape that they are pyramid-like shape or planar shape, facets of them are all facets 111. That is, there are many triangular faces having 60° angles. Degrees of orientation measured by XRD are different from one another. They were 0.68 in Example 1, 1.44 in Example 2, and 3.21 in Example 3. Since the diamond films have recesses and projections, facets to be observed are not parallel to the basal materials in many cases. Thus, it is natural that the degrees of orientation obtained by XRD do not match the facets recognized by microscopic observation. In a biased environment, ions are perpendicularly directed to the basal materials. Thus, it is reasonable that faces parallel to basal materials, in other words, the states of orientation determined by the degree of orientation, affect corrosion-erosion resistance.

Corrosion-erosion resistance tests described below were carried out to pieces of a silicon nitride sintered body with a diamond film formed thereon (Examples 1 to 3) and a piece of a silicon nitride sintered body without a diamond film thereon (Comparative Example 1). The results are shown in Table 1, FIG. 2(a) to FIG. 2(c), FIG. 3(a) to FIG. 3(c), and FIG. 4(a) to FIG. 4(c). Except for the case in which a diamond film was exposed to nitrogen trifluoride plasma at high temperature (400° C.), each diamond film showed excellent corrosion-erosion resistance with about 1/10 or less of silicon nitride. When the films were exposed to nitrogen trifluoride plasma at high temperature (400° C.), Example 1 with a small degree of orientation showed the best corrosion-erosion resistance. It is also clear even in the SEM photographs of FIG. 4(a) to FIG. 4(c). For example, the ends of facets 111 are selectively chipped in Example 2, and partial chipping like vermicular holes is found in Example 3 as pointed by arrows in FIG. 4(c). Although there are some facets 100 even in Example 3, it was confirmed that there was little damage on the facets.

TABLE 1

| | | | | | Comp. |
|---|---|---|---|---|---|
| Sample | Unit | Ex. 1 | Ex. 2 | Ex. 3 | Ex. 1 |
| Roughness of | μm | 8 | 36 | 10 | — |
| diamond | | | | | |
| Adhesion | Mpa | 29 | 23 | 1 | — |
| strength | | | | | |
| Cl₂ plasma, with | mg/cm² | <0.2 | <0.2 | <0.2 | 3 |
| bias, 100° C. | | | | | |
| NF₃ + O₂ plasma, | mg/cm² | 0.3 | 0.5 | 0.5 | 12 |
| with bias, 100° C. | | | | | |
| NF₃ plasma, with | mg/cm² | 0.3 | 6 | 13 | 21 |
| bias, 400° C. | | | | | |
| ClF₃ plasma, no | mg/cm² | <0.2 | <0.2 | <0.2 | 10 |
| bias, 735° C. | | | | | |

### Examples 4-7

Subsequently, 5 wt. % of yttrium oxide was added as a sintering aid. An aluminum nitride sintered body compacted by hot pressing in nitrogen was prepared, and was cut into small pieces of 20 mm W (width)×20 mm L (length)×2 mm t (thickness) shape by using a diamond grinding stone. To the small pieces, silicon carbide was coated as an intermediate layer at 100 μm thickness by CVD (Example 4). Also, as an intermediate layer, a 1 μm-thick silicon nitride was coated by sputtering method (Example 5). Furthermore, metal silicon was coated at about 100 μm-thickness by a plasma-spraying method (Example 6). In Examples 4 to 6, 15 μm-thick diamond films were deposited by microwave CVD using hydrogen, oxygen as a starting gas. Basal material temperature in a film forming process was 740° C.

All crystal phases in Examples 4 to 6 were diamond phase with a minor non-diamond phase. Also, the degrees of orientation were 0.70 in Example 4, 0.63 in Example 5, and 0.74 in Example 6.

To pieces of an aluminum nitride sintered body having an intermediate layer of the aforementioned various kinds of materials and a diamond film deposited thereon (Examples 4 to 6) and a piece of an aluminum nitride sintered body without an intermediate layer and with a diamond film deposited thereon (Example 7), corrosion-erosion resistance tests described below were carried out. The results are shown in Table 2. Any diamond film showed preferable corrosion-erosion resistance. This shows that adhesion strength improves in comparison with the one with no intermediate layer.

TABLE 2

| Sample | Unit | Ex. 4 | Ex. 5 | Ex. 6 | Ex. 7 |
|---|---|---|---|---|---|
| Roughness of | μm | 8 | 8 | 8 | 8 |
| diamond | | | | | |
| Adhesion strength | MPa | 48 | 29 | 19 | 16 |
| Cl₂ plasma, with | mg/cm² | <0.2 | <0.2 | <0.2 | <0.2 |
| bias, 100° C. | | | | | |
| NF₃ + O₂ plasma, | mg/cm² | 0.3 | 0.3 | 0.3 | 0.3 |
| with bias, 100° C. | | | | | |
| NF₃ plasma, with | mg/cm² | 0.3 | 0.3 | 0.3 | 0.3 |
| bias, 400° C. | | | | | |
| ClF₃ plasma, no | mg/cm² | <0.2 | <0.2 | <0.2 | <0.2 |
| bias, 735° C. | | | | | |

### Example 8, Comparative Example 2

Subsequently, into isopropyl alcohol, were added aluminum nitride powder and magnesium oxide powder at 1.0 wt. % and acrylic resin binder in an appropriate amount. The resultant was mixed in a pot mill, and then granulated and dried by a spray granulator so as to give granules. Into the granules, were embedded a coiled resistance heater element made of molybdenum and a high frequency electrode. By pressure molding, a disc-like aluminum nitride heater with an electrode was prepared as shown in FIG. 7(a), FIG. 7(b) (Example 7). As a high frequency electrode, a metal mesh was used in which molybdenum wires of 0.4 mm φ in diameter were wound at the density of 24 wires per inch.

To the heater, as in Example 4, was coated silicon carbide to give 100 μm-thickness on a heating face by CVD as an intermediate layer. The silicon carbide film was ground to the thickness of about 50 μm by a diamond grinding stone. Furthermore, a diamond film was formed thereon under the same conditions as in Example 1 (Example 8). The degree of orientation of this diamond film was 0.41 when a test piece was cut out for measurement after the test mentioned below.

After the diamond film was formed, adhesion strength was measured in accordance with the Sebastian method. No peeling was confirmed when the film was pulled with a power up to 20 MPa in terms of stress. Also, electric resistance at the surface of the diamond film was measured at the interelectrode distance of 10 mm by a tester. The film showed some conductivity of 10 to 300 kΩ. Leak current between the high frequency electrode and the heater element and between the heater element and the heater surface was at the lower limit of measurement or below. Furthermore, when surface roughness was measured at 10 random locations, the average roughness Ra was 3 to 14 μm.

A difference between the highest temperature and the lowest temperature at the heating face of the heater was measured at 700° C. in a vacuum to evaluate thermal uniformity. The maximum temperature difference at the heating face was 5° C. A non-coated item without silicon carbide and diamond coatings, was prepared (Comparative Example 2), and thermal uniformity was evaluated. The maximum temperature difference at the heating face was 11° C.

A corrosion-erosion resistance test (details mentioned below) of biased nitrogen trifluoride was carried out to Example 8 while the heater was heated at 400° C. Subsequently, the surface of the diamond film was observed, but was in the state as in Example 1 and showed preferable corrosion-erosion resistance. In Comparative Example 2, fluorination reaction was remarkable, and aluminum trifluoride was clearly recognized. (Examples 9, 10, Comparative Example 3)

Then, a heater was prepared, like the heater built in a CVD apparatus shown in FIG. 8. Silicon nitride was used for a basal material, and a tungsten wire was embedded as a heater element. A diamond grinding stone was used for a final finish. A heater on whose heating face was coated with diamond under the same conditions as in Example 1 (Example 9), and a heater on whose heating face was coated with diamond under the same conditions as in Example 3 (Example 10), were prepared.

After the diamond films were formed, adhesion strength was measured in accordance with the Sebastian method. The film did not peel off in Example 9 when the film was pulled with a power up to 20 MPa in terms of stress. In Example 10, the diamond film peeled off at 3 MPa. Also, electric resistance at the surface of the diamond films was measured at the interelectrode distance of 10 mm by using a tester. Each film had some conductivity of 10 to 300 kΩ. Leak current between the heater element and the heater surface was at the lower limit of measurement or below. Furthermore, when surface roughness was measured at five random locations, the average roughness Ra was 1 to 20 μm.

A difference between the highest temperature and the lowest temperature at the heating face of the heaters was measured at 700° C. in vacuum to evaluate thermal uniformity. The maximum temperature difference at the heating face was 8° C. A non-coated item not coated with diamond was prepared (Comparative Example 3) to evaluate thermal uniformity. The maximum temperature difference at the heating face was 35° C. After this test, further peeling of the diamond film was visually observed in Example 9, but no peeling was found in Example 10.

In Example 9, a corrosion-erosion resistance test (details mentioned below) of biased nitrogen trifluoride was carried out while the heater was heated at 400° C. Subsequently, the surface of the diamond film was observed, but was as in Example 1 and showed preferable corrosion-erosion resistance. After this test, the degrees of orientation were measured. They were 0.55 in Example 9, and 2.8 in Example 10.

### Examples 11-13, Comparative Example 4

Then, a ring as shown in FIG. 9 was cut out from metal silicon having purity of 99.9999% or more. The outer diameter, the inner diameter and the thickness of the ring are 230 mm, 201 mm and 5 mm, respectively. For a final finish, a diamond grinding stone was used. Although the ring is totally circular in FIG. 9, it may be provided with an orientation flat or a notch, depending on the shape of a treating object such as a silicon wafer.

A diamond film was deposited to the ring by the same method as in Example 1 until the thickness thereof became 15 μm at the top face. The diamond film was formed at about several μm at each inner face and outer face. Basal material temperature during a film forming process was 730° C. Three rings were prepared (Examples 11 to 13).

Example 11 was evaluated. As in Example 1, a crystal phase consisted of diamond and a non-diamond phase. Relatively many facets 100, in other words, square faces having angles of 90° were recognized. The degree of orientation was 0.72.

A nitrogen trifluoride plasma erosion resistance test was carried out on the ring in Example 12 at high temperature (400° C.). The test period was two hours. The ring was set so as to receive ion bombardment at the top face. After the test, the ring was cut out, and the top face was observed by SEM. As in Example 1, preferable corrosion-erosion resistance was shown. Both side faces were similarly observed, but corrosion-erosion at the sides was negligible. The side faces had the same fine structure as that before the test.

In Example 13, the diamond film was removed only from the inner side face and the outer side face. That is, metal silicon was exposed at both side faces, and the diamond film was provided only at the top face. When the plasma test is carried out to the ring in Example 13, the inner side face, top face, and outer side face are exposed to plasma. The area of a part with the diamond film and the area of parts with no diamond film—that is, the area of parts where metal silicon is exposed—are about 98 cm² and about 68 cm², respectively. The area ratio of the diamond film is 59%. During actual use, the inner side face is shielded with a silicon wafer or a susceptor. Thus, even with the same ring, an area with no diamond will be about 32 cm², and the area ratio of the diamond film will be 75%.

The same test as in Example 11 was carried out. The top face showed the same preferable corrosion-erosion resistance as in Example 1, but both side faces were thinned by about 100 μm. The same test was further repeated 10 times, but the diamond film remained on the top face. The thinning of the side faces was stopped at about 600 μm thickness. This is probably because it became harder for plasma to spread around the side surfaces because of the diamond at the top face working as a barrier.

The same corrosion-erosion test was carried out on a ring made of diamond, but not provided with a diamond film (Comparative Example 4) as in a final finish. Corrosion-erosion was remarkable, and every face was thinned by about 100 μm.

Additionally, in case of ordinary corrosion-erosion resistance coatings, all the portions to be exposed to plasma or corrosive gas are coated. There are some cases in which only one part is coated, but it is basically due to the limitation of coating techniques. The coating structure of Example 13 is superior in that the long life of a member is secured at low costs by using, as a corrosion margin, parts having little effect in a thickness direction or on etching characteristics.

In case of using, for instance, an oxide etching process, fluorine radical F* may be consumed by fluorination reaction at sides of a silicon wafer. Thus, the preferential (or selective) etching may improve so that an oxide layer is etched without etching polysilicon in a device, or the like.

It is preferable that the parts without a diamond film are side faces, but may be a part of a main face (surface). Although the method of removing a diamond film after manufacturing was mentioned, the method of masking in the deposition process of a diamond film, or conventional selective growth techniques may be applied. In case of using metal silicon for a basal material, it is preferable to use the metal silicon having purity of 99.999% (5N) or more purity, more preferably, 99.9999% (6N) or more. This is to prevent the film from contamination with metal by providing the same purity as the purity of a silicon wafer. In case of using single crystal silicon for a basal material, it is preferable to provide the so-called 100 plane or 111 plane as main facets.

### Examples 14, 15, Comparative Example 5

Then, three each of the ring made of silicon nitride (Example 14) and ring made of silicon carbide (Example 15) in the same shape as the rings in Examples 11 to 13 were prepared. For a final finish, a diamond grinding stone was used. In Example 14, ceria (CeO₂: cerium oxide) was added at 5 wt. %, and was sintered by hot pressing in nitrogen atmosphere, and was compacted up to the theoretical density ratio of 99% or more. The content of the elements of the group 1a and the groups 4a to 3b in a sintered body is less than 50 ppm. In Example 15, 1 wt. % of boron and 0.5 wt. % of carbon were added, and were similarly compacted to 95% or more in argon atmosphere by hot pressing. The content of the elements of the group 1a and the groups 4a to 3b, except for boron, is less than 50 ppm.

Three each of ring of Example 14 and Example 15 were prepared, and a diamond film was deposited by the same method as in Example 1 until the thickness at a top face became 15 μm. Each inner side face and outer side face was formed with the diamond film only at about several μm. Basal material temperature in a film forming process was 730° C.

One ring in Example 14 and one in Example 15 were evaluated. As in Example 1, a crystal phase consisted of diamond phase and a non-diamond phase. Relatively many facets 100, in other words, square faces having angles of 90° were recognized. The degree of orientation was 0.60 each. Density strength was 35 MPa in Example 15, and was 42 MPa in Example 14.

A nitrogen trifluoride plasma erosion resistance test was carried out using another ring in Example 14 and Example 15 at high temperature (400° C.). The test period was two hours. The rings were set so as to receive ion bombardment at the top face. After the test, the rings were cut out, and the top faces were observed by SEM. As in Example 1, preferable erosion resistance was shown. Both side faces were similarly checked, but erosion at the sides was negligible. The side faces had the same fine structure as that before the test.

The diamond film was removed only from the inner side face and the outer side face of the remaining one ring of Example 14 and Example 15. In other words, silicon nitride or silicon carbide was exposed at both side faces, and the diamond film was provided only at the top face. The nitrogen trifluoride plasma test was carried out at high temperature (400° C.). In both Example 14 and Example 15, the top faces showed the same preferable erosion resistance as in Example 1. Both side faces were thinned by about 30 μm in Example 15. The same test was further repeated 10 times, but the diamond film remained on the top face. The side faces were thinned by about 300 μm. Both side faces were thinned by about 10 μm in Example 14. Even after 10 repetitions, it was only about 50 μm and was small.

A ring depending on the diamond with no diamond film as in a final finish (Comparative Example 5 and Comparative Example 6) was also prepared, and the same corrosion-erosion tests were carried out. In any basal material, the same level of thinning as that of side faces was recognized.

Thus, when a basal material is a silicon-containing compound such as silicon nitride and silicon carbide, a main face is rarely thinned as in case of metal silicon. However, by thinning side faces, long life may be secured while the effects on semiconductor production processes are minimized.

Metal silicon, silicon nitride, silicon carbide are all suitable as basal materials. However, in consideration of adhesion to diamond and the precision of size, silicon nitride and silicon carbide are preferable. These ceramics are preferable in precision of size since a difference in thermal expansion with diamond is small. When diamond is deposited at high temperature, stress is generated based on a difference in thermal expansion with a basal material. However, diamond is a compound of high strength, so that it deforms a basal material. Since a ring-shaped member is installed around a substrate, size precision should be high, and small deformation is advantageous. Accordingly, when super high purity is desired, a silicon basal material should be selected.

### Example 16

There is provided a heater shown in FIG. 10 (Example 16) which is the same heater as in Example 8, but has no basal material between a high frequency electrode and a diamond film, and directly coated with diamond on the electrode. Exemplarily, the same heater as in Example 8 was prepared, and the film on a heating face was removed with a diamond grinding stone, thereby a molybdenum mesh high frequency electrode was exposed. Aluminum nitride as a basal material was in the openings of the mesh. Subsequently, a diamond film was formed at about 15 μm thickness by the same method as in Example 1.

As in Example 8, preferable results were obtained. This method is preferable in that the diamond film itself operates as a high frequency electrode. That is, in ordinary ceramic heaters, a high frequency electrode has to be embedded in a ceramic basal material to protect the electrode from corrosive gas. However, diamond has some conductivity, so that it also operates as a corrosion-erosion resistant electrode. Diamond is connected not to one location but to multiple points through the molybdenum mesh since the diamond film has electric resistance. If a diamond film of low resistance is obtainable by doping boron or the like, it may be electrically connected only to one location. However, boron affects the conductivity of a silicon wafer, so that the method of connecting diamond with some conductivity at multiple points is preferable. Regarding adhesion strength, no peeling was confirmed after the film was pulled with a power up to 20 MPa at random 10 locations.

(Evaluation of Crystal Phase and Degree of Orientation)

Crystal phases were determined by using both X-Ray Diffractometry (abbreviated as XRD) and Raman spectroscopy. In XRD, diamond films were set at the same level as a holder, and diffraction peaks were measured by the θ-2θ method. CuKα rays were used for X rays. After the presence of peaks were confirmed at about 43.9° and about 75.3° by the angle of diffraction 2θ, the height of both peaks was measured and the degree of orientation defined by the following formula (1) was calculated.

Degree of Orientation=[Im220/(Im220+Im111)]/[Ip220/(Ip220+Ip111)] . . . (1)

In the formula (1), Im220 indicates the intensity of 220 diffraction of diamond obtained by the θ-2θmethod from a coated diamond film. Similarly, Im111 indicates the intensity of 111 diffraction of diamond obtained by the θ-2θ method from a coated diamond film. Both are peak heights, but are considered as peak intensity.

Ip220 and Ip111 are the intensity of peaks diffracted from diamond powder, in other words, diamond at a non-oriented state. The data reported at the JCPDS card No. 6-0675 were used herein. In other words, Ip220=25, Ip111=100. Because it is the θ-2θ method, the formula (1) calculates the area ratio of {220} plane of diamond crystals within faces parallel to a basal material. When plane are deposited randomly, in other words, when they are non-oriented, the degree of orientation defined by the formula (1) becomes 1. When there are only a few diamond {220} plane in faces parallel to a basal material, the degree of orientation becomes smaller than 1. On the contrary, when there are many such plane, the degree of orientation becomes larger than 1.

The Raman spectrometry was used to confirm mainly whether or not non-diamond (amorphous carbon) was present. FIG. 11 shows the Raman spectrum of Example 1. A sharp peak around 1330 cm⁻¹ is diamond. A broad peak around 1500 cm⁻¹ is a non-diamond component. When there is a sharp peak around 1330 cm⁻¹, the main crystal phase is judged to be diamond.

(Measurement of Adhesion Strength)

The Sebastian method was applied. The Sebastian method is a method in which resinous adhesive is applied to one side of a 5 mm φ disc having a pull rod and is bonded and cured on a film, and the rod is pulled in a vertical direction to the disc. Adhesion strength is calculated by dividing a load at the time of detachment by a disc area. In case of detachment at the adhesive, the data is not included.

(Evaluation of Corrosion-Erosion Resistance)

First, evaluation was made in accordance with weight losses when a sample was exposed to chlorine gas plasma, nitrogen trifluoride+oxygen plasma, and oxygen plasma. Each was made plasmatic by ICP (Inductivelty-coupled Plasma) at 13.56 MHz (800 W), and the bias of 13.56 MHz (300 W) was added to a sample stage to bombard ions to a sample surface. In case of chlorine gas as corrosive gas, 130 sccm of chlorine gas and 50 sccm of nitrogen gas as carrier gas were run. In case of nitrogen trifluoride+oxygen, 75 sccm of nitrogen trifluoride and 75 sccm of oxygen were mixed and run, and 50 sccm of nitrogen gas was run as carrier gas. In the case of oxygen gas, 75 sccm of oxygen and, as carrier gas, 160 sccm of argon gas were run. A test period was 2 hours each. Pressure inside a chamber during the test was 0.1 Torr. Vdc, showing the degree of bias, was about 400 V. Stage temperature was about 100° C.

Subsequently, as a high temperature test, two types of tests were carried out. In the first test, as in the above-noted test, plasma was made by ICP at 13.56 MHz (800 W), and the bias of 13.56 MHz (300 W) was added to a sample stage to bombard ions to a sample surface. Also, 80 sccm of nitrogen trifluoride and 50 sccm of nitrogen gas were run for two hours each to test weight losses. Pressure during the test was 0.1 Torr. Vdc, showing the degree of bias, was about 400 V. The stage was also heated by an external heater, and stage temperature was set about 320° C.

In the second test, 100 sccm of chlorine trifluoride and 50 scam of nitrogen gas as carrier gas were run. These gases thermally dissociate, so that neither ICP nor bias was added. The test period was similarly two hours, and the pressure was 0.1 Torr. It was heated at 735° C. by an external heater.

(Surface Roughness)

Average roughness Ra was considered as roughness by using a surface roughness tester manufactured by Rank Taylor Bobson Co. Ltd. (Form Talysurf 2-S4) based on Japanese Industrial Standard B0601.

### Examples 17-19, Comparative Examples 7, 8

A disc-like aluminum alloy (A6061) having dimensions of 190 mmφ×10 mmt was prepared as a basal material, and an alumina layer of about 250 μm was formed on the aluminum alloy by a plasma-spraying method. Then, the thickness of the alumina layer was reduced by about 50 μm by grinding to obtain a plane. Thus, an electrostatic chuck was obtained (Comparative Example 7).

The following test was carried out to this electrostatic chuck, and the evaluation was given.

First, a silicon probe having a diameter of 2 cmφ was put on an alumina layer. The probe was pulled up with a direct current being applied between the basal material and the probe. Load was measured when the probe was peeled, and then polarity was reversed to carry out a similar measurement. Adhesion force was obtained by dividing the average value by a probe area (3.1 cm²).

In addition, a current passing between the probe and the basal material was measured during the above measurement, and the average value in the case that polarity was reversed was defined as a leak current.

Then, there was measured the time till the probe was peeled off in the case that voltage was switched off when the probe was pulled up to about one-third—half of the adhesive force in a predetermined applied voltage. The time was defined as a lagging time. The results of the test are shown in Table 3.

In Comparative Example 7, both the leak current and the lagging time were little, which is excellent. However, a high voltage of about 1000V or more was necessary to substantially adsorb (about 10 Torr or more) the alumina layer, which means that it needs sufficient insulation design.

Then, there was produced a susceptor where a composite of a molybdenum particle (particle diameter of 100-200 μm) and aluminum nitride was employed as an electrode (diamond coat susceptor 120 shown in FIG. 12). As the basal material was used aluminum nitride having an electric resistivity of 1×10¹⁰ Ωcm or more. The electrode was formed by being co-sintered with the basal substrate. The diamond film was formed on the upper surface by a microwave CVD method so as to have a thickness of about 10 μm and a surface roughness of 2-4 μm. Then, the diamond film was exposed to NF₃ plasma to improve resistivity up to 1×10¹⁶ Ωcm or more (Example 17).

The results of the same test as in the Comparative Example 7 are shown in Table 3. The resulting chunk shows the required adsorbability with about half voltage in comparison with that of a plasma-spraying type shown in Comparative Example 7. In addition, adhesion strength was evaluated after the adsorption to find it to be 25 Mpa or more.

Next, there was produced a susceptor where a composite of a molybdenum net (diameter of wire of 100-200 μm) and aluminum nitride was employed as an electrode, and aluminum nitride having a resistivity of 1×10¹⁰ Ωcm or more was used as a basal material (diamond coat susceptor 130 shown in FIG. 13). The electrode was formed by being co-sintered with the basal substrate. Then, the upper surface was ground until the molybdenum net was exposed. The diamond film was formed in the same manner as in Example 17 (Example 18).

The results of the same test as in the Comparative Example 7 are shown in Table 3. Table 3 shows that adsorption was carried out with about half voltage in comparison with that of a plasma-spraying type shown in Comparative Example 7.

Next, there was produced a susceptor where a composite of a molybdenum net (diameter of wire of 100-200 μm) and aluminum nitride was employed as an electrode, and aluminum nitride having a resistivity of 1×10⁸ Ωcm or more was used as a basal material (diamond coat susceptor 140 shown in FIG. 14). The electrode was formed by being co-sintered with the basal substrate. Though the upper surface was ground, the molybdenum net was not exposed, and machining was performed so that the aluminum nitride has a thickness of about 300 μm. The diamond film was formed in the same manner as in Example 17 (Example 19).

The results of the same test as in the Comparative Example 7 are shown in Table 3. The resulting chunk shows the required adsorbability with about half voltage in comparison with that of a plasma-spraying type shown in Comparative Example 7.

Then, an electrostatic chuck was produced in the same manner as in Example 19 except that a diamond film was not formed (Comparative Example 8).

The results of the same test as in the Comparative Example 7 are shown in Table 3. Though the electrostatic chuck has excellent adsorption force, it is inferior to the Examples 17-19 in the point of a large leak current and a large lugging time.

TABLE 3

| | Applied | Adsorb- | Leak | |
|---|---|---|---|---|
| | voltage | Ability | current | Lugging time |
| Unit | V | Torr | nA | sec |
| Example 17 | 250 | 1 | <0.1 | — |
| | 500 | 10 | <0.1 | 0 |
| | 750 | 24 | 9 | 0 |
| Example 18 | 250 | 1 | <0.1 | — |
| | 500 | 14 | <0.1 | 0 |
| | 750 | 32 | 2.6 | 0 |
| Example 19 | 250 | 2 | <0.1 | — |
| | 500 | 12 | <0.1 | 0.3(4 Torr) |
| | 750 | 20 | 0.5 | 1.9(10 Torr) |
| Comparative | 500 | <1 | <0.1 | — |
| Example 7 | 750 | 7 | <0.1 | — |
| | 1000 | 14 | <0.1 | 0 |
| | 1500 | 39 | <0.1 | 0 |
| | 2000 | 75 | <0.1 | 0 |
| Comparative | 100 | 2 | 1.5 | — |
| Example 8 | 200 | 12 | 9.8 | 1.3(4 Torr) |
| | 300 | 25 | 30 | 5.4(13 Torr) |

### Example 20-23, Comparative Example 9

There was prepared a silicon nitride sintered body obtained by being sintered to be densified in nitrogen with adding 3 wt. % of yttria and 2 wt. % of magnesia as sintering aids. A piece having dimensions of 25 mm (diameter)×2 mm (thickness) was cut off from the silicon nitride sintered body, which has a volume resistivity of about 1×10¹⁴ Ω·cm at room temperature, a thermal conductivity of 100 W/mK, a coefficient of thermal expansion of 3.1×10⁶/° C., and a rupture tenacity K_{1c} of 10MN/m^{3/2}.

A diamond film having a thickness of 9-34 μm is deposited on the piece by the microwave CVD method with using methane, hydrogen and oxygen as raw material gases (Examples 20-23). In Examples 21-23, the pieces are surrounded by a silicon nitride sintered body of the same material and quartz glass, and Si was sputtered from silicon nitride and quartz glass with making the methane concentration to be 0 intermittently; thereby adding 0.49 wt. %-3.3 wt. % of Si component to the diamond film. Incidentally, only carbon and Si were analyzed. No component except for Si and carbon was not detected. Temparatures of the basal material were between 700-760° C. and the diamond films had a surface roughness of 2-9 μm in all Examples 20-23.

In each of Examples 20-23, a crystalline phase was constituted by diamond and a non-diamond phase. A degree of orientation obtained by the XRD measurement was different from one another: 0.69 in Example 20, 0.60 in Example 21, 0.52 in Example 22, and 0.43 in Example 23. A facet was clearly observed in each of Examples 20-22, while it was not clear in Example 23. For component analysis of a diamond layer were used a scanning type of electron microscope XL-30 produced by Royal Philips Electronics and an energy-dispersion type of spectroscopic analyzer DX-4.

The aforementioned corrosion-erosion test was carried out to the piece of a silicon nitride sintered body having the aforementioned diamond film thereon (Examples 20-23) and the piece of a silicon nitride sintered body not having the aforementioned diamond film (Comparative Example 9). The results are shown in Table 4. When the diamond films were exposed to nitrogen trifluoride plasma, they showed excellent corrosion-erosion resistance of about 1/100of silicon nitride. In oxygen plasma (100° C.), the diamond film having higher Si content showed higher corrosion-erosion resistance. It can be considered that the reason is because a SiO₂ film was formed on a surface of the diamond layer by a strick of the oxygen plasma to be resistant to oxygen plasma. This enables to impart resistance to not only halogen plasma but also oxygen plasma to the diamond film.

TABLE 4

| Sample | Unit | Example 20 | Example 21 | Example 22 | Example 23 | Comp. Ex. 9 |
|---|---|---|---|---|---|---|
| Thickness | μm | 34 | 24 | 26 | 9 | non- |
| of diamond | | | | | | coat |
| Si content | wt % | 0 | 0.49 | 1.78 | 3.3 | None |
| Adhesion | MPa | 43 | 45 | 40 | 47 | NA |
| strength | | | | | | |
| NF₃ plasma, | mg/cm² | 0.3 | 0.3 | 0.3 | 0.3 | 21 |
| with bias, | | | | | | |
| 400° C. | | | | | | |
| O₂ plasma, | mg/cm² | 2.8 | 1.8 | 0.7 | 0.3 | −0.5 |
| with bias, | | | | | | |
| 100° C. | | | | | | |

(Remarks: NA means no data available.)

The diamond-coated corrosion-erosion resistant member of the present invention was explained above, including the examples. However, it is needless to say that the present invention is not limited to these examples.

As described above, the diamond-coated member of the present invention may provide such various effects, as full resistance is demonstrated and the generation of contaminants such as fine particles and metal ions is prevented even though the member is under a harsher corrosive atmosphere of semiconductor production processes and is exposed to highly corrosive gas, more powerful plasma, and so forth. Accordingly, the member is applicable as, for instance, a heater for heating a substrate of a substrate treating device, a high-frequency electrode, a susceptor, an electrode plate, an electrostatic chuck, a dome, a bell-jar, a gas nozzle, a shower plate and peripheral members for a substrate.

What is claimed is:

1. A diamond-coated corrosion-erosion resistant member comprising a basal material and an adhered thin film covering at least one part of a surface of the basal material;
characterized in that the thin film is a diamond film of which main crystal phase is diamond; and
that in the diamond film, a degree of orientation of diamond {220} plane being present in faces parallel to the basal material is expressed by the following formula:
[Im220/(Im220+Im111)]/[Ip220/(Ip220+Ip111)]<1.

2. A diamond-coated corrosion-erosion resistant member comprising a basal material and an adhered thin film covering at least one part of a surface of the basal material;
characterized in that the thin film is a diamond film of which main crystal phase is diamond; and
that adhesion strength between the thin film and the basal material is 15 MPa or more.

3. The diamond-coated corrosion-erosion resistant member according to claim 1, wherein the basal material comprises at least one member selected from the group consisting of silicon carbide, metal silicon, silicon nitride, aluminum nitride and boron nitride.

4. The diamond-coated corrosion-erosion resistant member according to claim 1, wherein the basal material is a single crystal silicon.

5. The diamond-coated corrosion-erosion resistant member according to claim 1, wherein an intermediate layer comprising at least one member selected from the group consisting of silicon carbide, silicon nitride, aluminum nitride, silicon, carbon, tungsten and molybdenum is interposed between the basal material and the thin film.

6. The diamond-coated corrosion-erosion resistant member according to claim 1, wherein the total weight of the elements of the group 1a to the group 3b contained in the thin film is 50 one millionth or less of a total weight of the thin film.

7. The diamond-coated corrosion-erosion resistant member according to claim 1, wherein the thin film contains 0.01-10 mass % of at least one member selected from the group consisting of silicon, nitrogen and fluorine.

8. The diamond-coated corrosion-erosion resistant member according to claim 1, wherein corrosion loss due to 400° C. biased nitrogen trifluoride plasma of the thin film is 5 mg/cm²·h or less.

9. The diamond-coated corrosion-erosion resistant member according to claim 1, wherein the thin film comprises a plurality of diamond films having different electric resistivity.

10. The diamond-coated corrosion-erosion resistant member according to claim 1, wherein surface roughness of the thin film is roughly 1 to 100 μm.

11. The diamond-coated corrosion-erosion resistant member according to claim 1, wherein the thin film is roughly 1 to 500 μm thick.

12. The diamond-coated corrosion-erosion resistant member according to claim 1, wherein the member is a corrosion-erosion resistant member for use in a substrate treating device, and at least a part facing the substrate is coated with the thin film in the basal material.

13. A diamond-coated heater which is installed in a substrate treating device and comprises a basal material having an embedded heater element and an adhered thin film for coating at least a part of the basal material facing a substrate, to heat the substrate;
characterized in that the thin film is a diamond film of which main crystal phase is diamond; and
that adhesion strength between the thin film and the basal material is 15 MPa or more.

14. The diamond-coated heater according to claim 13, wherein the basal material comprises at least one member selected from the group consisting of silicon carbide, metal silicon, silicon nitride, aluminum nitride and boron nitride.

15. The diamond-coated heater according to claim 13, wherein the basal material is a single crystal silicon.

16. The diamond-coated heater according to claim 13, wherein the thin film is coated at a coated area ratio of 10 to 90% relative to a surface area of the basal material.

17. The diamond-coated heater according to claim 13, wherein an intermediate layer comprising at least one member selected from the group consisting of silicon carbide, silicon nitride, aluminum nitride, silicon, carbon, tungsten and molybdenum is interposed between the basal material and the thin film.

18. The diamond-coated heater according to claim 13, wherein the total weight of elements of the group 1a to the group 3b contained in the thin film is 50 one millionth or less of a total weight of the thin film.

19. The diamond-coated heater according to claim 13, wherein the thin film contains 0.01-10 mass % of at least one member selected from the group consisting of silicon, nitrogen and fluorine.

20. The diamond-coated heater according to claim 13, wherein corrosion loss due to 400° C. biased nitrogen trifluoride plasma of the thin film is 5 mg/cm²·h or less.

21. The diamond-coated heater according to claim 13, wherein the thin film comprises of a plurality of diamond films having different electric resistivity.

22. The diamond-coated heater according to claim 13, wherein surface roughness of the thin film is roughly 1 to 100 μm.

23. The diamond-coated heater according to claim 13, wherein the thin film is roughly 1 to 500 μm thick.

24. The diamond-coated heater according to claim 13, wherein, in the diamond film, a degree of orientation of diamond {220} plane being present in faces parallel to the basal material is expressed by the following formula:
[Im220/(Im220+Im111)]/[Ip220/(Ip220+Ip111)]<1.

25. The diamond-coated heater according to claim 13, having a high-frequency electrode function and/or an electrostatic chuck function.

26. A diamond-coated ring being installed in a substrate treating device and around a substrate and comprising a basal material and an adhered thin film for coating at least a part of the basal material facing a substrate;
characterized in that the thin film is a diamond film of which main crystal phase is diamond; and
that adhesion strength between the thin film and the basal material is 15 MPa or more.

27. The diamond-coated ring according to claim 26, wherein the basal material comprises at least one material selected from the group consisting of silicon carbide, metal silicon, silicon nitride, aluminum nitride and boron nitride.

28. The diamond-coated ring according to claim 26, wherein the basal material is a single crystal silicon.

29. The diamond-coated ring according to claim 26, wherein the thin film is coated at a coated area of 10 to 90% relative to a surface area of the basal material.

30. The diamond-coated ring according to claim 26, wherein an intermediate layer comprising at least one member selected from the group consisting of silicon carbide, silicon nitride, aluminum nitride, silicon, carbon, tungsten and molybdenum is interposed between the basal material and the thin film.

31. The diamond-coated ring according to claim 26, wherein the total weight of elements of the group 1a to the group 3b contained in the thin film is 50 one millionth or less of a total weight of the thin film.

32. The diamond-coated ring according to claim 26, wherein the thin film contains 0.01-10 mass % of at least one member selected from the group consisting of silicon, nitrogen and fluorine.

33. The diamond-coated ring according to claim 26, wherein corrosion loss due to 400° C. biased nitrogen trifluoride plasma of the thin film is 5 mg/cm²·h or less.

34. The diamond-coated ring according to claim 26, wherein the thin film comprises a plurality of diamond films having different electric resistivity.

35. The diamond-coated ring according to claim 26, wherein surface roughness of the thin film is roughly 1 to 100 μm.

36. The diamond-coated ring according to claim 26, wherein the thin film is roughly 1 to 500 μm thick.

37. The diamond-coated ring according to claim 26, wherein, in the diamond film, a degree of orientation of diamond {220} plane being present in faces parallel to the basal material is expressed by the following formula:
[Im220/(Im220+Im111)]/[Ip220/(Ip220+Ip111)]<1.

38. A diamond-coated susceptor being installed in a substrate treating device, comprising a basal material and an adhered thin film for coating at least a part of the basal material facing a substrate, and having an electrode in the basal material or between the basal material and the thin film, to mount the basal material thereon;
characterized in that the thin film is a diamond film of which main crystal phase is diamond; and
that adhesion strength between the thin film and the basal material is 15 MPa or more.

39. A diamond-coated susceptor according to claim 38, wherein the basal material has a volume resistivity of 100 M Ωcm or more.

40. A diamond-coated susceptor according to claim 38, wherein the basal material comprises at least one material selected from the group consisting of silicon carbide, metal silicon, silicon nitride, aluminum nitride and boron nitride.

41. A diamond-coated susceptor according to claim 38, wherein the electrode comprises a composite body obtained by co-sintering a ceramic material and a metallic material.

42. A diamond-coated susceptor according to claim 38, wherein the electrode comprises a material containing 50% or more of at least one metallic material selected from the group consisting of silicon, tungsten, molybdenum and Kovar.

43. A diamond-coated susceptor according to claim 38, wherein the total weight of elements of the group 1a to the group 3b contained in the thin film is 50 one millionth or less of a total weight of the thin film.

44. A diamond-coated susceptor according to claim 38, wherein the thin film contains 0.01-10 mass % of at least one member selected from the group consisting of silicon, nitrogen and fluorine.

45. A diamond-coated susceptor according to claim 38, wherein corrosion loss due to 400° C. biased nitrogen trifluoride plasma of the thin film is 5 mg/cm²·h or less.

46. A diamond-coated susceptor according to claim 38, wherein the thin film comprises a plurality of diamond films having different electric resistivity.

47. A diamond-coated susceptor according to claim 46, wherein the plurality of diamond films includes a film having a high electric resistivity on the side facing the substrate and a film having conductivity on the basal material side.

48. A diamond-coated susceptor according to claim 38, wherein surface roughness of the thin film is roughly 1 to 100 μm.

49. A diamond-coated susceptor according to claim 38, wherein the thin film is roughly 1 to 500 μm thick.

50. A diamond-coated susceptor according to claim 38, wherein, in the diamond film, a degree of orientation of diamond {220} plane being present in faces parallel to the basal material is expressed by the following formula:
[Im220/(Im220+Im111)]/[Ip220/(Ip220+Ip111)]<1.

51. A method for producing a diamond-coated susceptor being installed in a substrate treating device, comprising a basal material and an adhered thin film for coating at least a part of the basal material facing a substrate, and having a metal-containing electrode disposed in the basal material or interposed between the basal material and the thin film; the method comprising the steps of:
embedding an electrode in the basal material with molding a basal material,
co-sintering the basal material and the electrode,
machining-removing a surface of the basal material to expose the electrode to the surface of the basal material, followed by forming a diamond film on surface of the basal material,
imparting high electric resistance to the diamond film by a plasma treatment, and
connecting a terminal to the electrode.
